(19) United States
(12) Patent Application Publication
(10) Pub. No.: US 2023/0171014 A1
(43) Pub. Date: Jun. 1, 2023

(54) TECHNIQUE FOR DETERMINING RADIO DEVICE RESIDENCE TIME AND SCHEDULING

(71) Applicant: Telefonaktiebolaget LM Ericsson (publ), Stockholm (SE)

(72) Inventors: Dhruvin PATEL, AACHEN (DE); Torsten DUDDA, WASSENBERG (DE); John Walter DIACHINA, GARNER, NC (US); Zhenhua ZOU, SOLNA (SE)

(73) Assignee: Telefonaktiebolaget LM Ericsson (publ), Stockholm (SE)

(21) Appl. No.: 17/920,648

(22) PCT Filed: Apr. 23, 2020
(86) PCT No.: PCT/EP2020/061366

§ 371 Date: Oct. 21, 2022

(51) Int. Cl. H04J 3/06

(52) U.S. Cl. CPC H04J 3/0667; H04J 3/0673

(57) ABSTRACT

A technique for determining a radio device residence time, RDRT (620), and scheduling the radio device (100) accordingly is described. More specifically, and without limitations, according to a first method aspect, a method for determining the RDRT (620) for a radio device (100) in radio communication with a network node (200) of a telecommunications network is provided, comprising a step of setting, at the radio device (100), a first time stamp (602) of a packet of the radio communication, wherein the first time stamp (602) is indicative of a time (602) of handling (720) the packet at a first layer (506) of a protocol stack at the radio device (100). The method further comprises a step of transmitting the packet to the network node (200) through a second layer (508) of the protocol stack, the second layer (508) being below the first layer (506) in the protocol stack. In a first variant, the packet comprises the first time stamp (602) of the packet for determining the RDRT (620) based on a difference between the first time stamp (602) and a second time stamp (710; 712) of the packet, wherein the packet is configured to initiate setting the second time stamp (710; 712) upon handling (724; 726) the packet at the telecommunications network. In a second variant, the packet comprises the RDRT (620) determined based on a difference between the first time stamp (602) of the packet and a second time stamp of the packet set at the radio device (100), wherein the second time stamp is indicative of a time of handling (722) the packet at the second layer (508) of the radio device (100). In a third variant, the packet comprises the first time stamp (602) of the packet and a second time stamp of the packet set at the radio device (100), wherein the second time stamp is indicative of a time of handling (722) the packet at the second layer (508) of the radio device (100), wherein the packet is configured to initiate determining, at the telecommunications network, the RDRT (620) based on a difference between the first time stamp (602) and the second time stamp.

### TECHNICAL FIELD

The present disclosure relates to a technique for determining a radio device residence time and scheduling the radio device accordingly. More specifically, and without limitation, methods and devices are provided for determining a radio device residence time and for scheduling a radio device according to a determined radio device residence time.

### BACKGROUND

Wireless private or campus networks fulfill a wide range of communication use cases over a single communication infrastructure. Such a network serves applications that require various Quality of Service (QoS) levels, e.g. in terms of reliability and latency. A use case of particular interest in manufacturing industries is machine-type communications (MTC). Usually, a private or campus network spans a limited geographical area.

The Third Generation Partnership Project (3GPP) is currently working towards supporting Time Sensitive Networking (TSN) features within wireless communications, in particular within the fifth generation of wireless communication technology or radio access technology (RAT), which is briefly referred to as 5G. TSN is conventionally based on the IEEE 802.3 standard for Ethernet, i.e. wired communications, whereas 5G involves wireless radio communications using RATs according to 3GPP Long Term Evolution (LTE) and/or 3GPP New Radio (NR). TSN describes a collection of features, including time synchronization, for transmissions with a guaranteed level of low latency and high reliability to make legacy Ethernet, which is designed for best-effort communications, deterministic.

The Osnabruck 15-16 May 2019 IEEE Conference contribution “Reliable and Deterministic Mobile Communications for Industry 4.0: Key Challenges and Solutions for the Integration of the 3GPP 5G System with IEEE” by C. Mannweiler et al. discusses deployment scenarios for an integrated 5G-TSN system in so-called “Industry 4.0” environments, focusing on radio access, core, and network management aspects as well as QoS mapping framework.

The article “Time Synchronization in 5G Wireless Edge: Requirements and Solutions for Critical-MTC” by A. Mahmood et al. (IEEE Communications Magazine Vol. 57, Issue 12, Dec. 2019) discusses device-level synchronization needs of critical MTC applications such as industrial automation, power distribution, vehicular communication and live audio/video production. Timestamping of precision time protocol (PTP) synchronization messages is performed at TSN translators (Us) at ingress and egress of a 5G system, and a residence time in the 5G system is determined from the difference in egress and ingress timestamps. Such a 5G residence time comprises a variety of, e.g. estimated, timing errors such as device-to-base station propagation delay.

Ultra-reliable and low-latency communication (URLLC) requirements challenge the design of a radio access network (RAN) and the corresponding RAT in terms of fast scheduling and short and robust transmissions. In particular, lacking knowledge of timing errors at the radio device or overly conservative estimates of timing errors delay the scheduled start time of a transmission opportunity and impede the integration of TSN in communication systems that are at least partially wireless, such as a deployment of the 5G private or campus network integrated within a TSN network.

### SUMMARY

Accordingly, there is a need for a radio communication technique that supports radio scheduling in time-critical communications, preferably a radio communication technique that enables Time Sensitive Networking (TSN) communications over a telecommunications network.

As to a first method aspect, a method of determining a radio device residence time (RDRT) for a radio device in radio communication with a network node of a network, e.g. a cellular or telecommunications network, is provided. The method comprises or initiates a step of setting, at the radio device, a first time stamp of a packet of the radio communication, wherein the first time stamp is indicative of a time of handling the packet at a first layer of a protocol stack at the radio device. The method further comprises or initiates a step of transmitting the packet to the network node through a second layer of the protocol stack, the second layer being below the first layer in the protocol stack.

In a first variant, the packet comprises the first time stamp of the packet for determining the RDRT based on a difference between the first time stamp and a second time stamp of the packet, wherein the packet is configured to initiate setting the second time stamp upon handling the packet at the (e.g., cellular or telecommunications) network and/or at the network node.

In a second variant, which may be combined with the first variant, the packet comprises the RDRT determined based on a difference between the first time stamp of the packet and a second time stamp of the packet set at the radio device, wherein the second time stamp is indicative of a time of handling the packet at the second layer of the radio device.

In a third variant, which may be combined with the first and/or second variant, the packet comprises the first time stamp of the packet and a second time stamp of the packet set at the radio device, wherein the second time stamp is indicative of a time of handling the packet at the second layer of the radio device. The packet is configured to initiate determining, at the (e.g., cellular or telecommunications) network and/or at the network node, the RDRT based on a difference between the first time stamp and the second time stamp.

By setting the first time stamp upon handling the packet at the first layer that is above the second layer used for the transmission of the packet to the network, at least some embodiments support the, e.g. telecommunications or cellular and/or a 5G system, network in scheduling a time-critical radio communication. For example, the embodiments support dynamically allocating radio resources for the radio device in the radio communication depending on the RDRT. Preferably, the embodiments enable a TSN communication over the network by scheduling a start time of a transmission opportunity based on the RDRT.

Same or further embodiments support the network in reducing latency and/or improving reliability of the radio communications. For example, the embodiments provide the network (e.g., the network node) with the RDRT or information necessary to determine the RDRT. Hence, the technique can enable the network (e.g., the network node) to schedule the radio resources more accurately and/or to prioritize traffic involving the radio device. For example, radio resources may be scheduled for the radio device depending on a delay contribution at the radio device as represented by the RDRT.

For example, a priority level (PL) for packets in the radio communication involving the radio device may be increased relative to another radio device so as to compensate for the RDRT of the radio device being longer as compared to the RDRT of the other radio device. Alternatively or in addition, radio resources may be scheduled by the network for an earlier point in time to compensate for the RDRT of the radio device.

Examples of the PL may include at least one of a Quality of Service (QoS), a 5G QoS Indicator (5GI) for 3GPP NR, a QoS Class Indicator (QCI) for 3GPP LTE, and an Allocation and Retention Priority (ARP).

The packet may be configured to initiate the setting of the second time stamp upon handling the packet at the network node and/or at a user plane function (UPF) of the, e.g. telecommunications, network, e.g., in the first variant. Alternatively or in addition, the packet comprising the RDRT may be transmitted to the network node, e.g., in the second variant. Alternatively or in addition, the packet may be configured to initiate the determining of the RDRT at the network node, e.g., in the third variant.

Same or further embodiments can enable TSN communications over the network, e.g., the telecommunications or cellular network and/or a 5G system. By transmitting the packet, which is indicative of the RDRT and/or enables the network (e.g., the network node) to determine the RDRT, the network (e.g., the network node) can schedule the radio device for a TSN communication that involves the radio communication between the radio device and the network node.

The radio communication may be a leg of the TSN communication or a segment of the TSN communication. The radio communication may be any wireless communication, e.g., any radio communication based on scheduling radio resources.

Alternatively or in addition, scheduling information for the radio device in the radio communication may be provided by means of the packet. The scheduling information may depend on knowledge of the RDRT at the network and/or at the network node (e.g., a Next Generation Node B or gNB).

The method may be implemented as a scheduling mechanism or a (e.g., dynamic) radio resource allocation, which takes the determined RDRT into account for the scheduling or allocation of (e.g., temporal) radio resources or resources in a time-domain of the radio communication.

The network (e.g., the telecommunications or cellular network) may comprise a 5G system and/or may provide radio access to the radio device according to 3GPP NR.

The RDRT may be defined as the time taken within a radio device to forward or process the packet from the first layer, e.g. a Device-Side TSN Translator (DS-TT), to the second layer, e.g. a radio layer 1 (L1) and/or radio layer 2 (L2), of the protocol stack. The second layer may be lower in the protocol stack than the first layer.

The first layer, e.g., as implemented at the radio device may have a corresponding first layer implemented at the network, e.g., at the network node. The second layer, e.g., as implemented at the radio device may have a corresponding second layer implemented at the network, e.g., at the network node. Due to this correspondence, the feature requiring that the second layer is “lower in the protocol stack than the first layer” may be applicable, e.g., to the first variant or any implementation wherein the second layer triggering the setting of the first time stamp is implemented at the radio device and the first layer triggering the setting of the second time stamp is implemented at the network (e.g., at the network node).

The first layer may comprise any one of the 3GPP Layer 3 (L3) such as a Radio Resource Control (RRC) layer. Alternatively or in addition, the first layer may comprise any one of a 3GPP Layer 2 (L2), a Packet Data Convergence Protocol (PDCP) layer, a Radio Link Control (RLC) layer and a Medium Access Control (MAC) layer.

The second layer may comprise any one of a 3GPP L2, a PDCP layer, an RLC layer and a MAC layer. Alternatively or in addition, the second layer may comprise any one of the 3GPP Layer 1 (L1) such as a Physical (PHY) layer.

The RDRT may be the same for uplink (UL) and downlink (DL) transmissions. For example, the RDRT may be determined in an UL transmission of the packet and applied to a DL transmission (e.g., due to channel reciprocity), or vice versa. Alternatively or in addition, The RDRT may be determined for each of an UL transmission and a DL transmission.

The second time stamp may be set at the second layer of the protocol stack at the radio device, e.g., in the second variant and/or the third variant.

Alternatively or in addition, e.g., in the first variant, the second time stamp may be set at the (e.g., telecommunications or cellular) network and/or at the network node. The second time stamp may be set at the network and/or the network node upon arrival of the packet and/or when receiving the packet at a layer, e.g., a second layer (e.g. the 3GPP Layer 2), of the protocol stack, which is lower than a first layer of the protocol stack.

Alternatively or in addition, the second time stamp may be set at the network, e.g. at the network node, e.g., when the packet is delivered to a layer, e.g., a first layer (e.g. the 3GPP L3 or higher) of the protocol stack, which is higher than the second layer of the protocol stack. Further alternatively or in addition, the second time stamp may be set at the network upon (e.g., transparently) forwarding the packet from the network node in or to the network (e.g., to a core network or through a backhaul network of the, e.g. telecommunications, network). The second time stamp may in some embodiments only be set for special packets (e.g., time protocol packets or synchronization packets), preferably for Precision Time Protocol (PTP) packets or generalized PTP (gPTP) packets.

The first time stamp, e.g. a DS-TT time stamp, may be defined as the time of establishing a session, e.g. a Packet Data Unit (PDU) session, by the radio device with the network (e.g., the time of PDU Session Establishment with a 5G network).

The telecommunications network may be comprised in, e.g. may be a leg of, a TSN network. The TSN network may comprise an end station, e.g. an MTC or narrowband Internet of Things (NB-IoT) or Industrial Internet of Things (IIoT) device, in wired communication with the radio device. Alternatively or in addition, the end station of the TSN network may be embodied by the radio device.

The determining of the RDRT may further be based on a time offset. The time offset may comprise a duration of handling the packet at the second layer of the protocol stack at the radio device. Alternatively or in addition, the time offset may comprise a duration at the second layer for segmenting and/or encoding and/or buffering the packet at the radio device. Further alternatively or in addition, the time offset may comprise a radio propagation of the transmitted packet from the radio device to the network node, optionally according to a timing advance of the radio device for the network node.

The step of receiving the packet may encompass receiving one or more re-transmissions of the packet. Alternatively or in addition, the step of receiving the packet may encompass decoding the packet at the network node. Further alternatively or in addition, the step of receiving the packet may encompass combining segments of the packet at the network node.

The RDRT may be determined at the network node or by a dedicated network entity, e.g., a Centralized Network Configuration (CNC) entity of the network. Alternatively or in addition, the RDRT may be based on the difference of the second time stamp (i.e., the time indicated by the second time stamp) set at the network node, the first time stamp (i.e., the time indicated by the second time stamp) set at the radio device and a time offset (e.g., a constant time offset). The time offset may comprise a scheduling time of the second layer (e.g., a 3GPP Layer 1 and/or a 3GPP Layer 2) or an air interface and/or a transmission time of the second layer or an air interface for the transmission between the radio device and the network node. Alternatively or in addition, the time offset may comprise at least one of a buffering time of the radio device (e.g. at a 3GPP Layer 2 and/or a 3GPP Layer 1), an encoding time of the radio device, an air interface transmission time (e.g. a transmission slot length) and a decoding delay of the network node.

The RDRT may be used or required to enable a deterministic scheduling mechanism for information (e.g., user data or user plane information) to be transmitted in or through (e.g., the UL of) the radio communication (e.g., as a leg of a TSN stream). Alternatively or in addition, based on the determined RDRT, the network (e.g., the network node or a dedicated network entity, e.g. the CNC entity) may schedule the radio device optimally or more accurately (e.g., compared to an otherwise conservative and/or greater estimate of the RDRT), e.g., thereby reducing latency in the radio communication and/or improving the probability of meeting an end-to-end delay requirement, e.g., a packet delay budget (PDB) and/or improving reliability of the information transmission.

The radio communication may be an Ultra-Reliable Low-Latency Communication (URLLC). The URLLC may specify the PDB. Based on the determined RDRT, the network (e.g., the network node) may control packet transport in a backhaul network or a core network, CN, and/or may control the scheduling of radio resources for the radio device to fulfill the PDB.

The network node may be a base station or a radio access node of the (e.g. telecommunications or cellular) network. Alternatively or in addition, the radio device may be a user equipment (UE).

With a time reference delivery method introduced in the 3GPP Release 16, it is possible for a radio device to have the same time reference as a network node, e.g., with a granularity of nanoseconds. By the above method, the network node can determine the RDRT (e.g., as a time from a DS-TT port as the first layer to a lower layer as the second layer of protocol stack at the radio device), e.g., the time taken by the packet from the application layer (e.g., a DS-TT port) till the Media Access Control (MAC or “lower”) layer of the protocol stack at the radio device.

Without the technique disclosed herein, the RDRT could or would otherwise be unknown to the network node.

The information, e.g. the RDRT, is further utilized by the (e.g. telecommunications) network, e.g. the network node, to optimize the radio resource scheduling mechanism in order to fulfill deterministic communication requirements. For example, by having access to the RDRT information, the (e.g. telecommunications or cellular) network, e.g. the network node or a dedicated network entity such as a CNC entity, can avoid always conservatively scheduling or overly conservatively scheduling radio resources for the radio device by assuming an overly large RDRT.

Based on the RDRT, the (e.g., telecommunications or cellular) network, preferably the network node, may schedule the radio device, e.g., more optimally and/or assuming a shorter or more accurate RDRT. Thus, the network (preferably, the network node) may be able to improve latency performance of the radio communication (also referred to as “on the air interface”), which improves the probability of the end-to-end PDB requirements being realized. Alternatively or in addition, the reliability of the transmission is improved and/or jitter is reduced, e.g. by ensuring that a scheduled packet is ready for transmission from the radio device.

Transmitting the first time stamp may further initiate setting the second time stamp of the packet at the (e.g. telecommunications) network, e.g. at the network node.

Alternatively, the method may further comprise a step of setting the second time stamp of the packet at the radio device.

The method may further comprise a step of determining, at the radio device, the RDRT based on the difference between the first time stamp of the packet and the second time stamp of the packet set at the radio device.

Handling the packet at the first layer and/or at the second layer may comprise an arrival of and/or receiving the packet at the respective layer. Alternatively or in addition, handling the packet at the first layer and/or at the second layer may comprise forwarding of the packet from the respective layer (e.g., of the protocol stack at the radio device) to another layer (e.g., in the protocol stack at the radio device) or forwarding to the network node.

The first layer of the protocol stack may handle the packet according to a TSN. Alternatively or in addition, the second layer of the protocol stack may handle the packet according to a radio access technology (RAT) of the radio communication. Further alternatively or in addition, the first layer and the second layer of the protocol stack may handle the packet according to a RAT of the radio communication.

The first layer may translate the packet between the TSN and the RAT.

At the radio device and/or upon transmission of the packet, arrival of the packet at the first layer may also be referred to as ingress from the TSN and/or as ingress to the first layer. At the network node and/or upon reception of the packet, forwarding of the packet from the first layer may also be referred to as egress from the first layer and/or as egress to the TSN.

Arrival of the packet at the second layer for reception of the packet may also be referred to as ingress to the second layer. Forwarding of the packet from the first layer for reception may also be referred to as egress from the first layer.

The first layer may be an application layer or a transport layer. The first layer may comprise a TSN application layer of the protocol stack. Alternatively or in addition, the first layer may comprise a translator configured to translate packets between a domain of the TSN and a domain of the radio communication. Further alternatively or in addition, the first layer may comprise an ingress point to the TSN application layer, which may be above a RAT of the radio communication within the protocol stack at the radio device. Still further alternatively or in addition, the first layer may comprise an ingress point to layers comprising a RAT of the radio communication within the protocol stack at the radio device, which may be below a TSN application layer.

The translator may be a device-side TSN translator (DS-TT). The DS-TT may be implemented by a TSN Translator and Adaptation Interface (AIF).

The DS-TT may correspond to the ingress point to the application layer of the radio device. The ingress point of the radio device may be configured according to a TSN Centralized User Configuration (CUC) entity.

The second layer may comprise a Packet Data Convergence Protocol (PDCP) layer of the radio device. Alternatively or in addition, the second layer may comprise a Radio Link Control (RLC) layer of the radio device. Further alternatively or in addition, the second layer may comprise a Medium Access Control (MAC) layer of the radio device. Still further alternatively or in addition, the second layer may comprise a Physical (PHY) layer of the radio device.

The method may further comprise a step of receiving, at the radio device, a message indicative of scheduling information of at least one of an uplink (UL) transmission from the radio device and a downlink (DL) transmission to the radio device. The scheduling information, e.g. for an UL transmission, may be based on the determined RDRT.

The scheduling information may depend on the determined RDRT. The RDRT may be determined, e.g., in an UL transmission of the packet and be applied to DL transmissions by channel reciprocity, or vice versa.

Alternatively or in addition, the scheduling information may depend on a packet delay budget (PDB). The PDB may be determined by the TSN.

The PDB may correspond to an upper limit of the delay suffered by a packet between the radio device and the control plane of the, e.g. telecommunications, network, e.g. a Policy and Charging Enforcement Function (PCEF). A PDB between the radio device and the control plane of the (e.g. telecommunications or cellular) network may be denoted as end-to-midpoint PDB.

Alternatively or in addition, the PDB may correspond to an upper limit of the delay suffered by a packet between, e.g. TSN, endpoint devices. A PDB between, e.g. TSN, endpoint devices may be denoted as end-to-end PDB.

The UL transmission may be from the radio device to the network node.

The scheduling information may comprise a scheduling grant of the UL transmission and/or a scheduling assignment of the DL transmission. Scheduling may be performed by the (e.g. telecommunications) network, preferably by the network node. Alternatively or in addition, the scheduling may depend on a TSN schedule, preferably received from a dedicated TSN entity, e.g. a Centralized Network Configuration (CNC) entity. The scheduling information may be provided by the (e.g. telecommunications) network, preferably by the network node. Alternatively or in addition, the TSN schedule may be provided by the TSN, preferably by the dedicated TSN entity, e.g. the CNC entity.

The scheduling information may be received from the network node.

The scheduling information may be further based on at least one of a PDB and an end-to-end delay requirement.

The PDB and/or the end-to-end delay requirement may be provided by or received from the TSN. Alternatively or in addition, the PDB and/or the end-to-end delay requirement may be provided by or received from a CUC entity. Further alternatively or in addition, the PDB and/or the end-to-end delay requirement may be provided by or received from the radio device. Still further alternatively or in addition, the PDB and/or the end-to-end delay requirement may be provided by or received from an application of the radio device.

The scheduling information may depend on a difference between the PDB and the determined RDRT.

The scheduling information may be indicative of a transmission opportunity, which is a function of the determined RDRT.

The transmission opportunity may comprise one or more transmission time intervals (TTIs). Alternatively or in addition, the transmission opportunity may comprise one or more short TTIs (sTTIs). The duration of a sTTI may be a fraction of a duration of a TTI.

The scheduling information may be indicative of a start time of the transmission opportunity. The scheduling information, e.g. for an UL transmission, may be based on the determined RDRT by indicating a first start time for a first value of the determined RDRT and indicating a second start time for a second value of the determined RDRT. A time span until the first start time may be less than a time span until the second start time if the first value of the determined RDRT is greater than the second value of the determined RDRT. Optionally, the time span until the first and/or second start time may be measured from the time that the packet is ready for transmission at the second layer.

The time span until the first start time may be shorter than the time span until the second start time if the associated determined RDRT is greater, e.g., in order to ensure that a given PDB is met. The sum of the RDRT and the PDB, e.g. of the Quality of Service (QoS) Flow, may need to be lower than a residence time upper bound requirement for a time-aware system specified in IEEE 802.1AS. Alternatively or in addition, the sum of the determined RDRT and the time span may be, e.g. approximately, constant. Alternatively or in addition, the time spans until the first and the second start time may be based on a comparison of the respective difference of the associated PDB and the associated RDRT.

Alternatively or in addition, the scheduling information may be indicative of a start time of the transmission opportunity. The scheduling information, e.g. for an UL transmission, may be based on the determined RDRT by indicating a first start time for a first value of the determined RDRT and indicating a second start time for a second value of the determined RDRT. A time span until the first start time may be less than a time span until the second start time if the first value of the determined RDRT is less than the second value of the determined RDRT. Optionally, the time span until the first and/or second start time may be measured from the time of handling the packet at the first layer.

The time span until the first start time may be shorter than the time span until the second start time if the associated determined RDRT is smaller, e.g., in order to minimize a waiting time and/or to transmit a packet as early as possible once it has become available and/or is ready for transmission, e.g. at the second layer. The time span may be long enough to ensure that the packet is ready for transmission, e.g. at the second layer. By ensuring that the packet is ready for transmission and/or by transmitting the packet as early as possible, channel congestion and/or jitter may be reduced.

The scheduling information may be indicative of a time window during which the transmission opportunity starts. The scheduling information may be based on the determined RDRT by indicating a first time window if a first value of the RDRT is determined and indicating a second time window if a second value of the RDRT is determined. The first time window may be greater than the second time window, and the first value of the determined RDRT may be less than the second value of the determined RDRT.

By scheduling the time window during which the transmission opportunity starts in dependence of the determined RDRT, the throughput of packets can be improved, e.g., for packets having a large value of the RDRT.

The scheduling information may be indicative of a duration of the transmission opportunity. The scheduling information, e.g. for an UL transmission, may be based on the determined RDRT by indicating a first duration for a first value of the determined RDRT and indicating a second duration for a second value of the determined RDRT. The first duration may be less than the second duration if the first value of the determined RDRT is greater than the second value of the determined RDRT.

The first duration may correspond to a first number of TTIs. The second duration may correspond to a second number of TTIs, which is larger than the first number of TTIs. Alternatively or in addition, the first duration may correspond to a first number of sTTIs, and the second duration may correspond to a second number of sTTIs, which is larger than the first number of sTTIs. Further alternatively or in addition, the first duration may correspond to one or more sTTIs, and the second duration may correspond to one or more TTIs. Optionally, the number of TTIs corresponding to the second duration may be equal to or greater than the number of sTTIs corresponding to the first duration.

The time span until the first start time may be shorter if the associated determined RDRT is smaller, e.g., in order to minimize a waiting time and/or to transmit a packet as early as possible once it has become available and/or is ready for transmission.

A scheduling time (e.g., the start time of the transmission opportunity) may be a monotonic decreasing and/or linear function of the RDRT. By scheduling the radio device, for which a longer RDRT is determined, with a higher priority and/or an earlier transmission opportunity and/or a shorter transmission opportunity, the PDB and/or end-to-end delay requirements for all radio devices and/or all users may be fulfilled.

The radio device and the (e.g. telecommunications) network may be synchronized with a time reference.

The synchronization may be performed by a, e.g. TSN, grandmaster clock. The, e.g. TSN, grandmaster clock may be implemented at the radio device. Alternatively or in addition, the, e.g. TSN, grandmaster clock may be implemented in the (e.g. telecommunications) network and/or at the network node. The (e.g. telecommunications) network may comprise a CNC entity. The CNC entity may comprise the, e.g. TSN, grandmaster clock in a, e.g. radio, network-side implementation.

By synchronizing the radio device and the network node, the RDRT may be determined based a difference of a first time stamp set, e.g., at the radio device and a second time stamp set, e.g., at the network node. The RDRT may be determined at the network node. Alternatively or in addition, the RDRT may be determined at a UPF Network-Side TSN Translator (NW-TT) or a dedicated RDRT determining entity.

The synchronization between the radio device and the network node may have a granularity and/or an uncertainty value in the range of nanoseconds.

The radio device may receive synchronization information indicative of a time reference from the network node and/or may transmit synchronization information indicative of a time reference to the network node.

The radio device may transmit an Information Element (IE) to the network node. The IE may be indicative of the time reference provided by the radio device. Alternatively or in addition, the network node may transmit an IE to the radio device. The IE may be indicative of the time reference provided by the, e.g. telecommunications, network.

The synchronization information may enable synchronizing a clock at the radio device that sets the first time stamp and a clock at the, e.g. telecommunications, network (e.g., at the network node) that sets the second time stamp. The synchronization information may be indicative of a time reference, e.g. a common time reference of the TSN.

Alternatively or in addition, the radio device may receive an IE from the network node. The IE may be indicative of the time reference. The IE may be comprised in a System Information Block (SIB) message. Alternatively or in addition, the IE may be comprised in a Radio Resource Control (RRC) message.

The synchronization information or the IE may be comprised in at least one of: a System Information Block (SIB) or System Information (SI) message; a Radio Resource Control (RRC) message; an Uplink Control Information (UCI); and a Downlink Control Information (DCI).

The synchronization information or the IE may comprise at least one of: a value for a granularity of the time reference; and a value for an uncertainty of the time reference.

The IE may comprise a granularity value of the time reference. Alternatively or in addition, the IE may comprise an uncertainty value of the time reference. The IE may provide a time reference at nanosecond granularity and/or uncertainty, e.g. of the order of 10 ns.

Handling the packet at the first layer and/or at the second layer may comprise setting the first time stamp and/or the second time stamp, respectively, based on the time reference.

The packet may comprise a header. The header may be indicative of the packet being a time protocol packet.

The packet (e.g., the time protocol packet) may comprise a message according to a time protocol, optionally according to at least one of a Precision Time Protocol (PTP) or a generalized PTP (gPTP).

The message according to the time protocol may also be referred to as a time protocol message. The packet comprising the time protocol message may also be referred to as the time protocol packet. The message according to the PTP and the gPTP may also be referred to as a PTP message and gPTP message, respectively. The packet comprising the PTP message and the gPTP message may also be referred to as PTP packet and gPTP packet, respectively.

The packet may comprise a header. The header of the packet may be indicative of the packet being a synchronization packet. The header of the packet may indicate to the network node and/or the radio device to set the second time stamp. Alternatively or in addition, the header may indicate to the network, e.g. the network node, to extract the RDRT from a data unit, e.g. a Packet Data Unit (PDU), associated to the packet.

The packet (e.g., the time protocol packet) may be transmitted in a time protocol session established between the radio device and the network node. In one variant, a packet transmission (e.g. the transmission of the packet) in the time protocol session may be dedicated to packets comprising a message according to a time protocol, preferably a PTP or a gPTP, and/or the packet comprising at least the first time stamp. In a second variant (which may be combined with the first variant), the first time stamp may be indicative of the time of establishing the time protocol session and/or of the time of receiving the, e.g. time protocol, packet at the radio device. In a third variant (which may be combined with the first variant or the second variant), the radio device may transmit a plurality of packets to the network node in at least two different sessions including the time protocol session. A header of a packet may be indicative of the packet, out of the plurality of packets, being associated to and/or transmitted in the time protocol session. The packet associated to and/or transmitted in the time protocol session may, by means of the header, be configured to initiate at least one of the setting of the second time stamp and the determining of the RDRT.

For example, by virtue of the packet belonging to the time protocol session and/or due to the header of a packet being indicative of the time protocol or the time protocol session, the packet is configured to initiate the setting of the second time stamp and/or the packet is configured to initiate the determining of the RDRT.

The time protocol session may be a Packet Data Unit (PDU) session between the radio device and the network node. Alternatively or in addition, the time protocol session may be established by a Packet Data Network (PDN) connection procedure performed between the radio device and the network node.

The header may comprise a bitflag or bit field indicating that the packet is special, e.g. a gPTP packet.

The transmission of the first time stamp and/or the transmission of the RDRT and/or the transmission of the first and the second time stamp may correspond to the transmission of the synchronization packet.

The packet may comprise a PTP packet or a gPTP packet.

Being configured to initiate the determining, e.g. of the RDRT, and/or the setting, e.g. of the first and/or second time stamp, may be implemented by the packet being a PTP packet or gPTP packet. A gPTP packet may also be denoted as gPTP synchronization frame or gPTP synch frame and/or as gPTP synchronization packet or gPTP sync packet.

At least one of the synchronization packet, the PTP packet and the gPTP packet may be received in a session established between the network node and the radio device. The first time stamp may be indicative of the time of establishing the session.

The session may be a dedicated session for transmitting the packet. The session may be a Packet Data Unit (PDU) session.

As to a second method aspect, a method of scheduling a radio device in radio communication with a network node of a (e.g. telecommunications) network is provided. The method may comprise or initiate a step of receiving, from the radio device, a packet of the radio communication.

In a first variant, the packet may comprise a first time stamp of the packet set at the radio device for determining an RDRT based on a difference between the first time stamp and a second time stamp of the packet, wherein the first time stamp is indicative of a time of handling the packet at a first layer of a protocol stack at the radio device, wherein the packet is received through a second layer of the protocol stack at the network node, the second layer being below the first layer in the protocol stack, and wherein the packet is configured to initiate setting the second time stamp upon handling the packet at the (e.g. telecommunications) network, e.g. at the network node.

In a second variant, the packet may comprise the RDRT determined based on a difference between a first time stamp of the packet and a second time stamp of the packet set at the radio device, wherein the first time stamp is indicative of a time of handling the packet at a first layer of a protocol stack at the radio device, and wherein the second time stamp is indicative of a time of handling the packet at a second layer of the radio device. The second layer may be below the first layer in the protocol stack.

In a third variant, the packet may comprise a first time stamp of the packet and a second time stamp of the packet set at the radio device, wherein the first time stamp is indicative of a time of handling the packet at a first layer of a protocol stack at the radio device, and wherein the second time stamp is indicative of a time of handling the packet at a second layer of the radio device. The second layer may be below the first layer in the protocol stack. The packet may be configured to initiate determining, at the (e.g. telecommunications) network, e.g. at the network node or a dedicated RDRT determining entity, the RDRT based on a difference between the first time stamp and the second time stamp.

The method of the second method aspect may further comprise or initiate a step of transmitting a message indicative of scheduling information of at least one of an UL transmission from the radio device and a DL transmission to the radio device. The scheduling information, e.g. for an UL transmission, may be based on the determined RDRT.

The second method aspect may be implemented by a network node, e.g. a gNB, or a base station.

The method of the second method aspect may further comprise a step of setting the second time stamp of the packet at the (e.g. telecommunications) network, e.g. at the network node.

The second time stamp may be set at arrival of and/or when receiving the packet at the network node. Alternatively or in addition, the second time stamp may be set at egress to a layer of the protocol stack at the network node. Further alternatively or in addition, the second time stamp may be set at egress to the (e.g. telecommunications) network. The layer may comprise an Internet Protocol (IP) layer, and/or a transport layer and/or an application layer.

The method of the second method aspect may further comprise the step of determining the RDRT based on a difference between the first time stamp of the packet and the second time stamp of the packet, optionally in response to the receiving of the packet being configured to initiate the determining.

The first time stamp may be set at the radio device. The second time stamp may be set at the telecommunications network (e.g., the network node) and/or at the radio device.

The determining of the RDRT may be further based on a time offset comprising a duration of handling the packet at the second layer, e.g. at the radio device. The handling of the packet at the second layer may preferably comprise a duration (e.g., at and/or the second layer) for segmenting the packet at the radio device and/or for encoding the packet at the radio device and/or for buffering the packet at the radio device.

Further alternatively or in addition, the determining of the RDRT may be based on a time offset comprising a radio propagation of the transmitted packet from the radio device to the network node, optionally according to a timing advance of the radio device for the network node.

The step of receiving the packet may encompass receiving one or more re-transmissions of the packet and/or decoding the packet at the network node and/or combining segments of the packet at the network node.

The second layer may also be referred to as an air interface. The time offset may encompass a duration for scheduling the packet at the second layer and/or a duration of the transmission of the packet at the second layer. Alternatively or in addition, the duration of the scheduling may encompass the duration of the buffering (e.g., until a radio resource of the radio communication is requested, granted and/or available). Alternatively or in addition, the duration of the transmission may correspond to the duration of the transmission opportunity or multiple transmission opportunities used for the transmission of the packet.

For example, the determining of the RDRT may be further based on the time offset by subtracting the time offset from the difference between the first time stamp and the second time stamp.

The network node may transmit scheduling information to a first radio device and a second radio device according to a priority of the first and a priority of the second radio devices. The priority of the respective radio device may depend on the RDRT determined for the respective one of the first and second radio devices. For example, the first radio device, for which a first RDRT is determined, may be scheduled with a first priority, and the second radio device, for which a second RDRT is determined, may be scheduled with a second priority. The first priority may be higher than the second priority if the determined first RDRT is greater than the determined second RDRT. Herein, scheduling the first radio device with a higher priority than the second radio device may be implemented by transmitting the scheduling information to the first radio device earlier as compared to the second radio device, and/or by a transmission opportunity for the first radio device that is earlier and/or shorter as compared to the second radio device, and/or by transmitting transmission opportunities to the first radio device more frequently as compared to the second radio device.

The RDRT may be determined for a first radio device and a second radio device. The scheduling information may be indicative of a first start time of the transmission opportunity for the first radio device and a second start time of the transmission opportunity for the second radio device. The first start time may be earlier the second start time if the RDRT determined for the first radio device is greater than the RDRT determined for the second radio device. Optionally, the first start time and the second start time are measured from the time that the packet is ready for transmission at the second layer.

The first start time may be earlier than the second start time if the associated determined RDRT is greater, e.g., in order to ensure that a given PDB and/or end-to-end requirement is met for all radio devices and/or all users.

Alternatively or in addition, the RDRT may be determined for a first radio device and a second radio device. The scheduling information may be indicative of a first start time of the transmission opportunity for the first radio device and a second start time of the transmission opportunity for the second radio device. The first start time may be earlier than the second start time if the RDRT determined for the first radio device is less than the RDRT determined for the second radio device. Optionally, the first start time and the second start time are measured from the time of handling the packet at the first layer.

The scheduling information may be indicative of a transmission opportunity, which is a function of the determined RDRT. The RDRT may be determined for each of a first radio device and a second radio device. The scheduling information may be indicative of a first time window during which the transmission opportunity of the first radio device starts. The scheduling information may further be indicative of a second time window during which the transmission opportunity of the second radio device starts. The first time window may be greater than the second time window if a value of the determined RDRT of the first radio device is less than a value of the determined RDRT of the second radio device.

The, e.g. first, radio device may communicate with another, e.g. second, radio device through the, e.g. telecommunications, network. The message may be indicative of scheduling information for an UL transmission from the, e.g. first, radio device, and for a DL transmission to the other, e.g. second, radio device.

In the first variant, the method may further comprise or initiate a step of determining the RDRT based on a difference between the first time stamp of the packet set at the radio device and the second time stamp of the packet set at the network node and/or at the (e.g. telecommunications) network. The RDRT may be determined, e.g., at the network node and/or by a dedicated RDRT determining entity.

In the third variant, the method may further comprise or initiate a step of determining the RDRT based on a difference between the first time stamp and the second time stamp of the packet set at the radio device.

Alternatively or in addition, in the second or third variant the packet may be transmitted, e.g. transparently, to a CN, e.g. a UPF. The transparent transmission may be a transmission from the radio device without inspection by the network node. The CN may provide the RDRT to the network node. In a first embodiment, the CN provides the RDRT every time it receives a corresponding packet. In a second embodiment, which may be combinable with the first embodiment, the CN determines an averaged RDRT based on a, e.g. predefined, number of packets. In a third embodiment, which may be combinable with the first and/or the second embodiments, the CN updates the RDRT if it differs from the previous RDRT, e.g. if the difference is above a predefined threshold.

Determining the RDRT may be further based on an, e.g. constant, offset. The, e.g. constant, offset may be based on or representative of a time for air interface scheduling and/or transmission.

The radio device may communicate with another radio device through the (e.g. telecommunications) network. The message may be indicative of scheduling information for an UL transmission from the radio device and for a DL transmission to the other radio device.

The second method aspect may further comprise any feature, or may comprise or initiate any step, disclosed in the context of the first method aspect or may comprise any feature or step corresponding thereto. For example, the scheduling may depend on a PDB and/or an end-to-end delay requirement, which in one embodiment, which is combinable with any other embodiment or variant, may be provided by the TSN.

Moreover, the first method aspect may be performed at or by a radio device, e.g. a UE, for an UL or a sidelink (SL) connection. Alternatively, or in combination, the second method aspect may be performed at or by a network node, e.g., a base station, for a DL or a SL or a backhaul connection.

The channel or link used for the data transmission and the radio reception, i.e. the channel between the radio device and the network node, may comprise multiple subchannels or subcarriers (as a frequency domain). Alternatively, or in addition, the channel or link may comprise one or more slots for a plurality of modulation symbols (as a time domain). Alternatively, or in addition, the channel or link may comprise a directional transmission (also: beamforming transmission) at the transmitter (e.g. the radio device and/or the network node), a directional reception (also: beamforming reception) at the receiver (e.g. the network node and/or the radio device) or a multiple-input multiple-output (MIMO) channel with two or more spatial streams (as a spatial domain).

The transmitter (e.g. the radio device and/or the network node) and the receiver (e.g. the network node and/or the radio device) may be spaced apart. The transmitter and the receiver may be in data or signal communication exclusively by means of the radio communication.

In any aspect, the radio device and the network node may form, or may be part of, a radio (e.g. telecommunications) network, e.g., according to the Third Generation Partnership Project (3GPP) or according to the standard family IEEE 802.11 (Wi-Fi). The radio (e.g. telecommunications) network may be a radio access network (RAN) comprising one or more base stations. Alternatively, or in addition, the radio (e.g. telecommunications) network may be a vehicular, ad hoc and/or mesh network. The first method aspect may be performed by one or more embodiments of the radio device in the radio (e.g. telecommunications) network. The second method aspect may be performed by one or more embodiments of the network node in the radio (e.g. telecommunications) network.

Any of the radio devices may be a mobile or wireless device, e.g., a 3GPP user equipment (UE) or a Wi-Fi station (STA). The radio device may be a mobile or portable station, a device for machine-type communication (MTC), a device for narrowband Internet of Things (NB-IoT), a device for Industrial Internet of Things (IIoT) or a combination thereof. Examples for the UE and the mobile station include a mobile phone, a tablet computer and a self-driving vehicle. Examples for the portable station include a laptop computer and a television set. Examples for the MTC device or the NB-IoT device or the IIoT device include robots, sensors and/or actuators, e.g., in manufacturing, automotive communication and home automation. The MTC device or the NB-IoT device or the IIoT device may be implemented in a manufacturing plant, household appliances and consumer electronics.

Any of the radio devices may be wirelessly connected or connectable (e.g., according to a radio resource control, RRC, state or active mode) with any of the network nodes (also: base stations). Herein, the base station may encompass any station that is configured to provide radio access to any of the radio devices. The base stations may also be referred to as transmission and reception point (TRP), network node, radio access node or access point (AP). The base station or one of the radio devices functioning as a gateway (e.g., between the radio, e.g. telecommunications, network and the RAN and/or the Internet) may provide a data link to a host computer providing the data. Examples for the base stations may include a 3G base station or Node B, 4G base station or eNodeB, a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a Radio Resource Control (RRC) layer and/or an application layer of a protocol stack.

As to another aspect, a computer program product is provided. The computer program product comprises program code portions for performing any one of the steps of the method aspects disclosed herein when the computer program product is executed by one or more computing devices. The computer program product may be stored on a computer-readable recording medium. The computer program product may also be provided for download, e.g., via the radio (e.g. telecommunications) network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for determining an RDRT for a radio device in radio communication with a network node is provided. The device may be configured to perform any one of the steps of the first method aspect.

As to a second device aspect, a device for scheduling a radio device in radio communication with a network node is provided. The device may be configured to perform any one of the steps of the second method aspect.

As to a further first device aspect, a device for determining an RDRT for a radio device in radio communication with a network node is provided. The device comprises at least one processor and a memory. Said memory may comprise instructions executable by said at least one processor whereby the device is operative to perform any one of the steps of the first method aspect.

As to a further second device aspect, a device for scheduling a radio device in radio communication with a network node is provided. The device comprises at least one processor and a memory. Said memory may comprise instructions executable by said at least one processor whereby the device is operative to perform any one of the steps of the second method aspect.

As to a still further aspect, a communication system including a host computer is provided. The host computer may comprise a processing circuitry configured to provide user data. The host computer may further comprise a communication interface configured to forward user data to a cellular (e.g. telecommunications) network for transmission to a user equipment (UE), wherein the UE comprises a radio interface and processing circuitry, a processing circuitry of the cellular network being configured to execute any one of the steps of the first and/or second method aspect.

The communication system may further include the UE. Alternatively, or in addition, the cellular network may further include one or more base stations and/or gateways configured to communicate with the UE and/or to provide a data link between the UE and the host computer using the first method aspect and/or the second method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the base station, the system or any node or station for embodying the technique may further include any feature disclosed in the context of the method aspects, and vice versa. Particularly, any unit and/or module, or any dedicated unit or module, may be configured to perform or initiate one or more of the steps of the first and/or second method aspect.

### BRIEF DESCRIPTION OF THE DRAWINGS

Further details of embodiments of the technique are described with reference to the enclosed drawings, wherein:

FIG. 1 shows an example schematic block diagram of a device for determining a radio device residence time (RDRT);

FIG. 2 shows an example schematic block diagram of a device for scheduling a radio device based on a determined RDRT;

FIG. 3 shows an example flowchart for a method of determining an RDRT, which method may be implementable by the device of FIG. 1;

FIG. 4 shows an example flowchart for a method of scheduling a radio device based on a determined RDRT, which method may be implementable by the device of FIG. 2;

FIG. 5 shows a schematic block diagram of a radio (e.g. telecommunications) network integrated with a TSN network through a radio device and a network node, which may be implementable by the devices of FIGS. 1 and 2, respectively;

FIG. 6A-6C schematically illustrate time lines of a radio transmission in a radio communication taking into account an RDRT;

FIG. 7 schematically illustrates handling of a packet and performing time stamps at a radio device and a network node, which may be implementable by the devices of FIGS. 1 and 2, respectively;

FIG. 8 schematically illustrates the communication between two radio devices, both of which may be implementable by copies of the device of FIG. 1, through a network node, which may be implementable by the device of FIG. 2;

FIG. 9 shows a TSN transmission selection with time aware gates associated to each of the queues;

FIG. 10 shows a 5G network structure including a radio device, e.g. the device of FIG. 1, and a network node, e.g. the device of FIG. 2, in a data plane;

FIG. 11 shows an example schematic block diagram of a radio device embodying the device of FIG. 1;

FIG. 12 shows an example schematic block diagram of a network node embodying the device of FIG. 2;

FIG. 13 schematically illustrates an example telecommunications network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including 3GPP LTE (e.g., LTE-Advanced or a related radio access technique such as MulteFire), in a Wireless Local Area Network (WLAN) according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

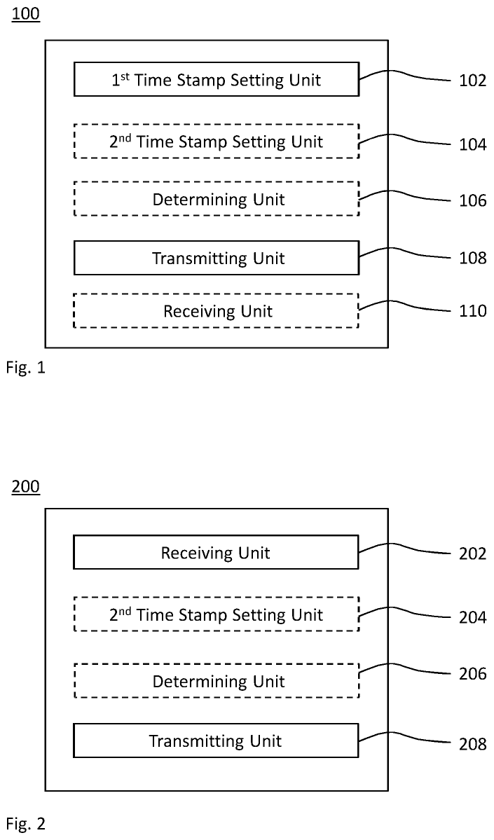

FIG. 1 schematically illustrates an example block diagram of a device for determining an RDRT for a radio device in radio communication with a network node of a (e.g. telecommunications) network. The device for determining the RDRT is generically referred to by reference sign 100.

The device 100 comprises a first time stamp setting unit 102 that sets a first time stamp of a packet of the radio communication. The first time stamp is indicative of a time of handling the packet at a first layer, e.g. at the application layer and/or DS-TT port, of a protocol stack at the radio device 100.

The device 100 further comprises a transmitting unit 108 that transmits the packet to the network node through a second layer, e.g. 3GPP Layer 1 (or PHY layer) and/or 3GPP Layer 2 (comprising MAC, RLC and PDCP layer), in the protocol stack, wherein the second layer is below the first layer in the protocol stack.

In a first variant, the packet comprises the first time stamp of the packet for determining the RDRT based on a difference between the first time stamp and a second time stamp of the packet, wherein the packet is configured to initiate setting the second time stamp upon handling the packet at the (e.g. telecommunications) network, e.g. at the network node.

Optionally, the device 100 comprises a second time stamp setting unit 104 that sets a second time stamp of the packet at the radio device 100, wherein the second time stamp is indicative of a time of handling the packet at the second layer of the radio device 100.

Further optionally, the device 100 comprises a determining unit 106 that determines the RDRT based on a difference between the first time stamp of the packet and the second time stamp of the packet, wherein both the first time stamp and the second time stamp are set at the radio device 100 by the first and second time stamps setting units 102 and 104, respectively.

In a second variant, the packet, which is transmitted by the transmitting unit 108, comprises the RDRT determined by the determining unit 106 based on the difference between the second and the first time stamps set by the time stamp setting units 104 and 102, respectively.

In a third variant, the packet comprises the first time stamp and the second time stamp set by the time stamp setting units 102 and 104, respectively, and the packet is configured to initiate determining, at the (e.g. telecommunications) network (e.g. at the network node or in a CN, to which the network node, e.g. transparently, forwards the packet), the RDRT based on the difference between the second time stamp and the first time stamp.

Optionally, the device 100 further comprises a receiving unit 110 that receives a message indicative of scheduling information of an UL transmission from the radio device 100 and/or scheduling information of a DL transmission to the radio device 100, wherein the scheduling information is based on the determined RDRT according to any variant.

Any of the units of the, e.g. radio, device 100 may be implemented by modules configured to provide the corresponding functionality.

The device 100 may also be referred to as, or may be embodied by, a radio device or a user equipment (UE). The device 100 and the network node are in a radio communication at least for the transmission of the packet at the device 100.

FIG. 2 schematically illustrates an example block diagram of device for scheduling a radio device in a radio communication with a network node based on a determined RDRT of the radio device. The device, e.g. a network node, for scheduling the radio device based on its RDRT is generically referred to by reference sign 200.

The device 200, e.g. a network node, comprises a receiving unit 202 that receives a packet of a radio communication from a radio device, e.g. the device 100.

In a first variant, the packet comprises a first time stamp of the packet for determining the RDRT based on a difference between the first time stamp and a second time stamp of the packet, wherein the first time stamp is indicative of a time of handling the packet at a first layer of a protocol stack at the radio device, and wherein the packet is configured to initiate setting the second time stamp upon handling the packet at the (e.g. telecommunications) network, e.g. at the network node 200.

Optionally, the device 200 comprises a second time stamp setting unit 204 that sets a second time stamp of the packet. The second time stamp setting unit 204 may set the second time stamp at arrival at the network node 200. Alternatively or in addition, the second time stamp setting unit 204 may set the second time stamp at egress of the packet to a layer of the communication protocol stack at the network node 200 and/or at egress to the network 500 (e.g. the telecommunications network 502).

Further optionally, the device 200 comprises a determining unit 206 that determines the RDRT based on a difference between the first time stamp of the packet set at the radio device and the second time stamp of the packet set at the network node 200 and/or at the radio device, e.g. the device 100.

In a second variant, the packet received from the radio device comprises the RDRT of the radio device determined by the radio device.

In a third variant, the packet received from the radio device comprises the first time stamp and a second time stamp set by the radio device. The first time stamp is indicative of a time of handling the packet at a first layer, e.g. the application layer and/or a DS-TT port, of the protocol stack at the radio device. The second time stamp is indicative of a time of handling the packet at a second layer, e.g. the PHY layer, of the protocol stack at the radio device. The second layer is below the first layer in the protocol stack at the radio device. The packet is configured to initiate determining, at the (e.g. telecommunications) network, the RDRT based on the difference between the second time stamp and the first time stamp, both of which are set at the radio device, e.g. at the time stamping units 104 and 102, respectively, of the device 100. Determining the RDRT may, according to the third variant be performed by the determining unit 206.

The device 200 further comprises a transmitting unit 208 that transmits a message indicative of scheduling information of an UL transmission from the radio device and/or scheduling information of a DL transmission to the radio device, wherein the scheduling information is based on the determined RDRT. Optionally, the scheduling information may further be based on a PDB and/or an end-to-end delay requirement.

Any of the units of the device 200 may be implemented by modules configured to provide the corresponding functionality.

The device 200 may also be referred to as, or may be embodied by, a network node or a base station. The device 200 and a radio device are in a radio communication at least for the reception of the packet and the transmission of the message indicative of scheduling information at the device 200.

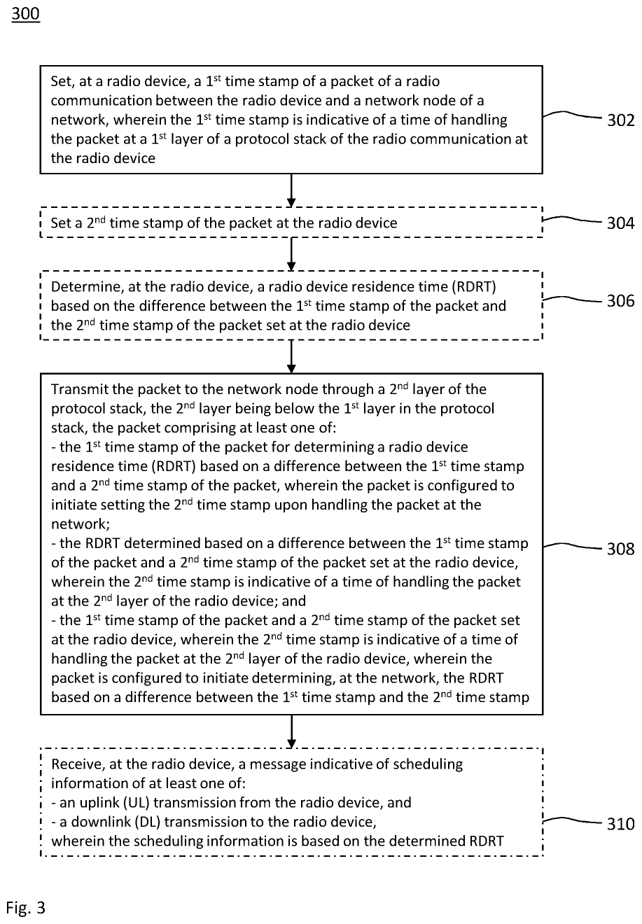

FIG. 3 shows an example flowchart for a method 300 of determining an RDRT for a radio device, e.g. the device 100, in radio communication with a network node, e.g. the device 200, of a (e.g. telecommunications) network. The method 300 comprises or initiates a step 302 of setting, at the radio device (e.g. the device 100), a first time stamp of a packet of the radio communication, wherein the first time stamp is indicative of a time of handling the packet at a first layer, e.g. the application layer and/or a DS-TT port, of a protocol stack at the radio device (e.g. the device 100).

Optionally, the method 300 further comprises or initiates a step 304 of setting a second time stamp of the packet at the radio device (e.g. the device 100).

Further optionally, the method 300 further comprises or initiates a step 306 of determining, at the radio device (e.g. the device 100), the RDRT based on the difference between the second time stamp of the packet and the first time stamp of the packet, both of which are set at the radio device (e.g. the device 100) in the steps 304 and 302, respectively.

The method 300 further comprises or initiates a step 308 of transmitting the packet to the (e.g. telecommunications) network (e.g. the network node 200) through a second layer, e.g. the PHY layer, of the protocol stack, the second layer being below the first layer in the protocol stack.

In a first variant, the packet comprises the first time stamp of the packet, set in the step 302, for determining the RDRT based on a difference between the first time stamp and a second time stamp of the packet, wherein the packet is configured to initiate setting the second time stamp upon handling the packet at the (e.g. telecommunications) network, e.g. at the network node.

In a second variant, the packet comprises the determined RDRT according to the step 306, e.g. determined by the determining unit 106 of the device 100, based on the first and second time stamps, which are set in the steps 302 and 304, respectively, e.g. by the time stamp setting units 102 and 104 of the device 100, respectively.

In a third variant, the packet comprises the first time stamp and the second time stamp both set at the radio device in the steps 302 and 304, respectively, e.g. by the time stamp setting units 102 and 104 of the device 100, respectively, and the packet is configured to initiate determining, at the (e.g. telecommunications) network (e.g. at the network node 200 or in a CN, to which the network node 200 transparently forwards the packet), the RDRT based on the difference between the first time stamp and the second time stamp, both of which are set at the radio device, e.g. the device 100, in the steps 302 and 304, respectively.

Optionally, the method 300 further comprises or initiates a step 310 of receiving, at the radio device (e.g. the device 100), a message indicative of scheduling information of at least one of an UL transmission from the radio device (e.g. the device 100) and a DL transmission to the radio device (e.g. the device 100), wherein the scheduling information is based on the determined RDRT.

The method 300 may be performed by the device 100. For example, the units 102, 104, 106, 108 and 110 may perform the steps 302, 304, 306, 308 and 310, respectively.

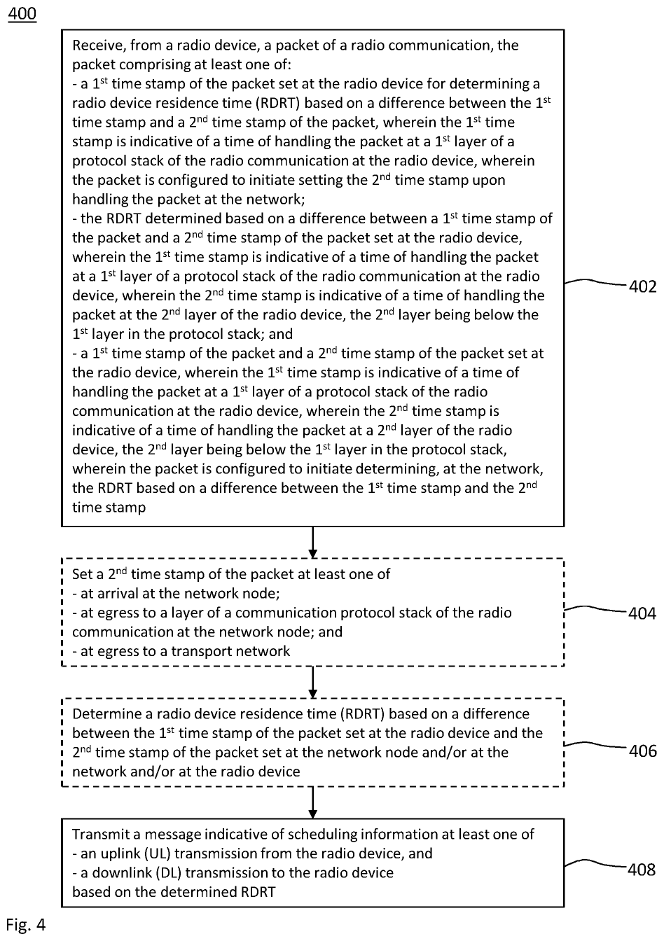

FIG. 4 shows an example flowchart for a method 400 of scheduling a radio device (e.g. the device 100) in a radio communication with a network node (e.g. the network node 200) of a (e.g. telecommunications) network. The method 400 comprises or initiates a step 402 of receiving, from the radio device (e.g. the device 100), a packet of the radio communication.

In a first variant, the packet comprises a first time stamp of the packet for determining the RDRT based on a difference between the first time stamp and a second time stamp of the packet, wherein the first time stamp is indicative of a time of handling the packet at a first layer, e.g. the application layer and/or a DS-TT port and/or a 3GPP Layer 2 (comprising MAC, RLC and PDCP layer), of a protocol stack at the radio device, e.g. the device 100, and wherein the packet is configured to initiate setting the second time stamp upon handling the packet at the (e.g. telecommunications) network, e.g. at the device 200.

Optionally, the method 400 further comprises or initiates a step 404 of setting a second time stamp of the packet at arrival at the network node (e.g. the device 200), and/or at egress to a layer of a communication protocol stack at the network node (e.g. the device 200), and/or at egress to the (e.g. telecommunications) network.

Further optionally, the method 400 comprises or initiates a step 406 of determining the RDRT based on a difference between the first time stamp of the packet set at the radio device (e.g. the device 100) and the second time stamp of the packet set at the network node (e.g. the device 200) and/or the second time stamp of the packet set at the radio device (e.g. the device 100).

The method 400 further comprises or initiates a step 408 of transmitting a message indicative of scheduling information of at least one of an UL transmission from the radio device (e.g. the device 100) and a DL transmission to the radio device (e.g. the device 100), wherein the scheduling information is based on the determined RDRT.

In a second variant, the packet received from the radio device (e.g. the device 100) comprises the RDRT of the radio device (e.g. the device 100) determined by the radio device (e.g. the device 100).

In a third variant, the packet received from the radio device (e.g. the device 100) comprises the first time stamp and a second time stamp set by the radio device (e.g. the device 100). The first time stamp is indicative of a time of handling the packet at a first layer, e.g. the application layer and/or a DS-TT port, of the protocol stack at the radio device (e.g. the device 100). The second time stamp is indicative of a time of handling the packet at a second layer, e.g. the PHY layer, of the protocol stack at the radio device (e.g. the device 100). The second layer is below the first layer in the protocol stack at the radio device (e.g. the device 100). The packet is configured to initiate determining, at the (e.g. telecommunications) network (e.g. at the device 200 embodying a network node), the RDRT based on the difference between the first time stamp set at the radio device (e.g. the device 100) and the second time stamp set at the radio device (e.g. the device 100).

The method 400 may be performed by the device 200. For example, the units 202, 204, 206 and 208 may perform the steps 402, 404, 406 and 408, respectively.

The technique may be applied to UL, DL or direct communications between radio devices, e.g., device-to-device (D2D) communications or SL communications.

The device 100 may be a radio device. The device 200 may be a network node. Herein, any radio device may be a mobile or portable station and/or any radio device wirelessly connectable to a base station or RAN, or to another radio device. A radio device may be a user equipment (UE), a device for machine-type communication (MTC) or a device for (e.g., narrowband or Industrial) Internet of Things (loT, e.g. NB-IoT or IIoT). Two or more radio devices may be configured to wirelessly connect to each other, e.g., in an ad hoc radio (e.g. telecommunications) network or via a 3GPP sidelink connection. Furthermore, any network node, e.g. a base station, may be a station providing radio access, may be part of a radio access network (RAN) and/or may be a node connected to the RAN for controlling radio access. Further, a network node may be an access point, for example a Wi-Fi access point.

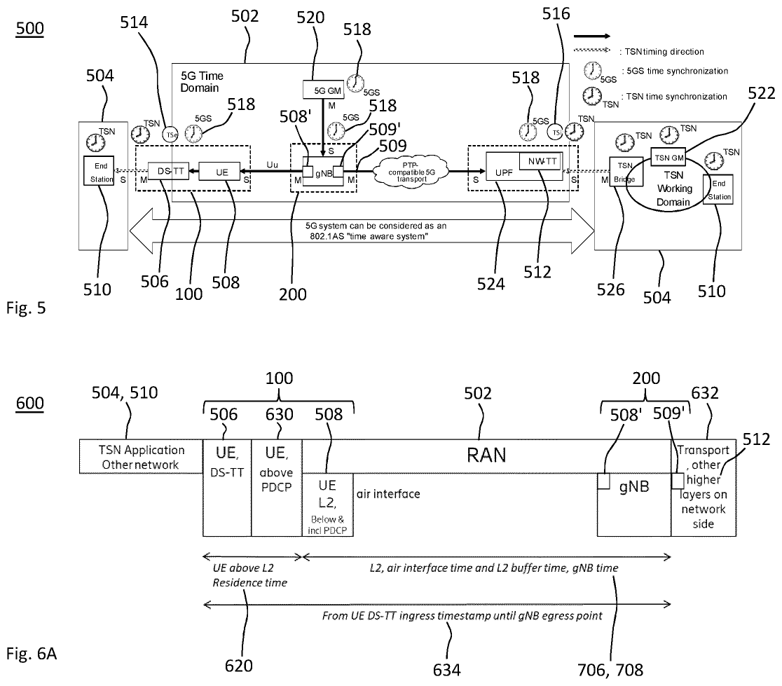

FIG. 5 schematically illustrates a network 500 comprising an, e.g. integrated, telecommunications-TSN architecture. The network 500 comprises a radio (also: wireless or cellular) or telecommunications network 502, e.g. a 5G network, and one or more TSNs 504.

Concerning a telecommunications-TSN, e.g. a 5G-TSN, integrated architecture, currently, 3GPP specifies the RDRT as radio device 100 (e.g. UE) Device-Side TSN Translator (UE-DS-TT, 506) residence time, which is defined as the time taken within the radio device 100, e.g. comprising the DS-TT 506, to forward a packet between the second layer, e.g. 3GPP Layer 1 (or PHY layer) and/or 3GPP Layer 2 (comprising MAC, RLC and PDCP layer), and the first layer, e.g. the DS-TT port and/or application layer. The RDRT is the same for the UL and DL traffic. According to the 3GPP document TS 23.501 V16.3.0, e.g. clause 5.27.5 item 1, the RDRT is provided as the time of the Protocol Data Unit (PDU) session establishment by the radio device, e.g. the device 100, to the network 500 (e.g. the telecommunications network 502).

Since residence times, including the RDRT, may vary among radio devices, e.g. UEs or multiple copies of the device 100, and among UPFs 524, the telecommunications, e.g. 5GS, bridge delay is determined after the PDU session establishment for the corresponding UPF 524 and the radio device, e.g. UE or one copy of the device 100. The RDRT is provided at the time of PDU Session Establishment by the radio device, e.g. UE or device 100, to the, e.g. telecommunications, network 502.

To satisfy time synchronization requirements for TSN in manufacturing use cases, a radio (e.g. telecommunications) network 502 is required to provide a time reference to which all machines (e.g. sensors and/or actuators, collectively referred to as end stations 510) can be synchronized.

Currently in 3GPP standardization, efforts are seen to realize a time synchronization over the LTE radio access in Release 15 and further in NR Release 16 as shown in FIG. 5. In FIG. 5, a grandmaster clock 520 of the telecommunications system 502, e.g. a 5G system, provides a time reference 518 to the network node 200, the radio device 100 and the UPF 524 comprising the network-side TSN translator (NW-TT) 512.

In the RRC protocol specification 3GPP document TS 38.331, V16.0.0, an Information Element (IE) providing information as to a time reference 518 is supported in the System Information Block 9 (SIB9) for broadcast transmission and in the RRC message DLInformationTransfer for RRC-unicast transmissions. The IE provides a time reference 518 with, e.g., 10 ns granularity and uncertainty value, to provide a telecommunications, e.g. 5G, clock time (e.g. 5G reference time) to the radio device, e.g. the device 100.

The main purpose of the synchronization procedure is to transfer a common telecommunications, e.g. 5G, reference time (e.g., 5G clock based on Global Positioning System, GPS, time reference 518 information) to radio devices, e.g. multiple copies of the device 100, along with inaccuracy (e.g. uncertainty) of the, e.g. reference time, information. Knowledge of the telecommunications, e.g. 5G, reference time at radio devices, e.g. multiple copies of the device 100, and within the telecommunications (e.g. 5G) network 502 (e.g. at/by a gNB 200 and/or a UPF Network-Side TSN Translator, UPF-NW-TT, 512) allows for timestamping to be performed at ingress (e.g. “TSi” 516) and egress (e.g. “TSe” 514) points of the legs of the TSN system within the telecommunications, e.g. 5G, system 502, and thereby allows for determining the telecommunications, e.g. 5G, system 502 residence time corresponding to information that passes through all or part of the telecommunications, e.g. 5G, system 502.

According to the 3GPP Release 17, it is possible to provide the TSN grandmaster reference clock from the radio device, e.g. UE or device 100, side to the (e.g. telecommunications) network 502 side (as a supplement to the case where the TSN grandmaster reference clock 522 resides within a TSN network node). Thereby, gPTP packets are envisaged to be timestamped with the telecommunications, e.g. 5G, reference time at the UE-DS-TT ingress point 514, in order to calculate the telecommunications, e.g. 5G, system residence time later at a telecommunications, e.g. 5G, system egress point 516 (e.g. at the network node/gNB 200 or at the UPF-NW-TT 512).

In order to satisfy deterministic communication services such as the transmission of TSN streams over telecommunications, e.g. 5G, systems 502, a network node 200 needs to know the telecommunications, e.g. 5G, system residence time experienced by TSN frames conveyed between the application layer and/or DS-TT port 506 and the lower layers 508 of the radio device, e.g. UE or device 100, in order to enable a deterministic scheduling mechanism for user plane information to be sent on the UL of the radio interface.

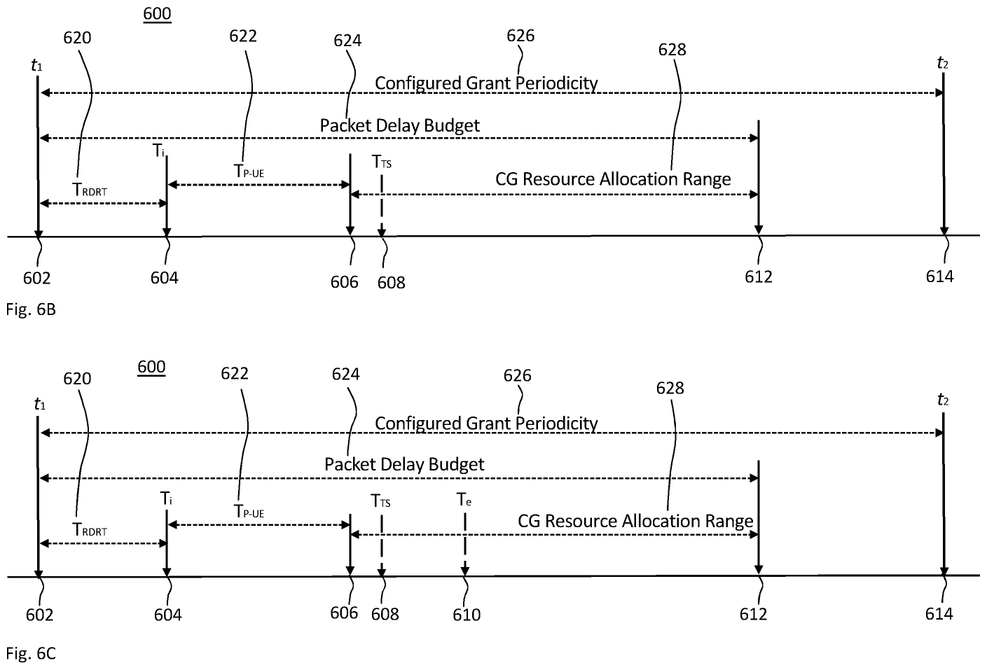

The RDRT (e.g. above 3GPP Layer 2), which may also be denoted as UE residence time or DS-TT residence time, is also one of the latency components in overall user plane latency from a radio device, e.g. UE or device 100, to a network node, e.g. gNB or device 200, as shown in FIG. 6A. The current invention discloses a method, e.g. the method 300, by which a network node, e.g. gNB or device 200, can calculate the RDRT at reference sign 620 in FIG. 6A, which is unknown so far to the network node, e.g. gNB or device 200.

FIG. 6A schematically illustrates the RDRT 620 and/or radio device processing time 706 contributions in a radio device, e.g. device 100, to a network node, e.g. device 200, latency.

It is assumed that the radio device, e.g. device 100, has a reference time based on the existing time reference 518 delivery method. For example, the radio device, e.g. device 100, and the network node, e.g. device 200, are synchronized to the same telecommunications, e.g. 5G, system 502 reference clock 520 with nanosecond accuracy. To measure the RDRT 620, packets entering the, e.g. UE, DS-TT 506 are timestamped with the, e.g. 5G, clock reference time provided by the network node, e.g. gNB or device 200. Once a packet is received over the user plane to the network node, e.g. gNB or device 200, its reception time is noted with the same, e.g. 5G, system reference clock. Alternatively or in addition, the time is noted when the packet is delivered to higher layers 632, e.g. at an 3GPP Layer 2 egress point of the network node, e.g. gNB or device 200, when relaying the packet to the UPF 524. Based on this information, e.g. the time at the 3GPP Layer 2 egress point, and network node, e.g. gNB or device 200, knowledge of the time it took for the transmission of the packet over the air interface 706 based on the transmission time scheduling, the RDRT can be determined and/or calculated.

In one embodiment, all or certain packets for an UL transmission ingressing the UE DS-TT 506 are timestamped with the, e.g. 5G, system reference time. In a sub-embodiment, which is combinable with any embodiment in this disclosure, those packets are gPTP packets originating from the radio device, e.g. UE or device 100, when the TSN grandmaster is implemented at the radio device, e.g. UE or device 100, side and synchronization is provided over the radio device, e.g. UE or device 100, UL to other devices, e.g. the network node or device 200.

In another embodiment, which is combinable with any other embodiment as disclosed herewith, the network node, e.g. gNB or device 200, inspects UL packets at reception or at egress points for timestamps, and if a time stamp from the radio device, e.g. UE or device 100, is included, the network node, e.g. gNB or device 200, notes the reception times or egress times, determines and/or calculates the reception time minus the radio device, e.g. UE or device 100, ingress timestamp or the egress time minus the radio device, e.g. UE or device 100, ingress timestamp, and considers those values for determination and/or calculation of the RDRT 620 as per the formula (1) below. In a sub-embodiment, which is combinable with any embodiment, the network node, e.g. gNB or device 200, may only evaluate gPTP packets received in the UL for the timestamp, i.e. the network node, e.g. gNB or device 200, inspects whether the received packets are gPTP packets.

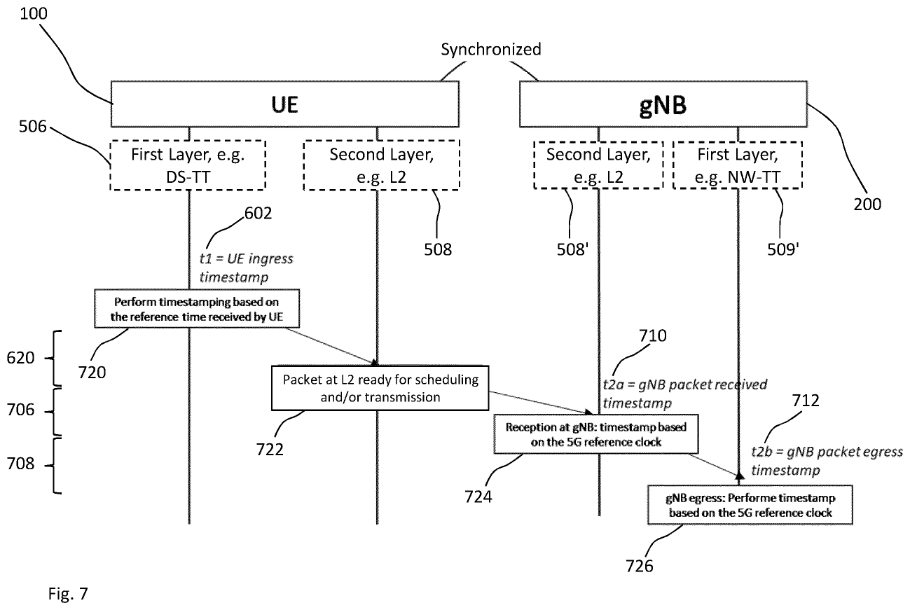

FIG. 7 schematically shows the handling of the packet at various layers of the devices 100 and 200 on the left-hand side and right-hand side, respectively, along with the accumulation of delay times at the left-hand side of FIG. 7.

According to an embodiment, which is combinable with any other embodiment, the three steps of determining the RDRT 620 are as follows:
1. Radio device, e.g. UE or device 100, ingress timestamping is performed at reference sign 720 for a packet coming from the TSN application towards the, e.g. UE, at the first layer, e.g. DS-TT port, 506 (t1 at reference sign 602). The ingress timestamping may correspond to setting a first time stamp, e.g. using the telecommunications, e.g. 5G, reference time.
   a. Optionally, the radio device, e.g. UE or device 100, when processing this packet at the second layer 508 (e.g. 3GPP L2), e.g. at reference sign 722, marks the packet by setting a certain bitflag in a regular packet header, this way indicating to the network node, e.g. gNB or device 200, that this is a packet (e.g. gPTP frame) for inspection.
2. When the packet arrives at the network node, e.g. gNB or device 200, at the second layer 508′ (e.g. 3GPP L2) with the same time reference, e.g. 5G, clock, the packet reception time is noted at reference sign 724 (t2a at reference sign 710), or alternatively or in addition, the packet egress time from the network node, e.g. gNB or device 200, to higher layers/a transport (e.g. telecommunications) network at reference sign 509′ (e.g. an NW-TT port 512) is noted at reference sign 726 (t2b at reference sign 712). Noting the packet reception and/or egress time may correspond to setting a second time stamp, e.g. using the telecommunications, e.g. 5G, reference time.
3. Based on the known scheduling and transmission time information at reference signs 706 and 708 by the network node, e.g. gNB or device 200, for that particular radio device, e.g. UE or device 100, the RDRT 620 (e.g. the residence time at the UE) can be calculated based on the formula (1) below.

$${T}_{RDRT} = t 2 ( gNB packet received timestamp t 2 a or packet delivered t 2 b ) - t 1 ( UE ingress timestamping ) - gNBknownAirinterfaceSchedulingTransmissionTime \qquad ( 1 )$$

The RDRT 620 determination is also schematically shown in the lower half of FIG. 6A, wherein at reference sign 634 the time span between the first and the second time stamp, which corresponds to the first two lines of formula (1), is displayed.

The network node, e.g. gNB or device 200, known air interface scheduling and transmission time consists of the following components:
Radio device, e.g. UE or device 100, 3GPP Layer 2 buffering at reference sign 706. E.g. when a packet arrives to the radio device, e.g. UE or device 100, 3GPP Layer 2 buffer, a scheduling request or buffer status report is triggered to the network node, e.g. gNB or device 200, and/or if UL resources are available, the data is directly transmitted. The time the data is buffered in the radio device, e.g. UE or device 100, until actual transmission can thus be known by the network node, e.g. gNB or device 200;
Radio device, e.g. UE or device 100, encoding time, specified values;
Air interface transmission time at reference sign 706, e.g. the transmission slot length;
   In case the, e.g. gPTP, message is re-transmitted, the air interface scheduling and transmission time comprises the time between when the, e.g. gPTP, message is first transmitted at the radio device, e.g. UE or device 100, and when the, e.g. gPTP, message is successfully decoded at the network node, e.g. gNB or device 200. In case the, e.g. gPTP, message is segmented at the RLC and/or MAC layer, the air interface scheduling and transmission time comprises the time between when the first segmented MAC PDU is first transmitted at the radio device, e.g. UE or device 100, and when the last segmented MAC PDU is successfully decoded at the network node, e.g. gNB or device 200.
The network node's, e.g. gNB or device 200, own decoding delay, until the reception time or the delivery time is noted, at reference sign 708 in FIG. 7.

If there are multiple packets at the radio device, e.g. UE or device 100, side, the RDRT may not or need not be determined from a, e.g. single, data or signal (e.g. scheduling request, SR, and/or buffer status report, BSR) transmission time, but multiple measurements (e.g. differences of time stamps, taking into account an optional constant time offset) may be performed and the minimum value may be determined to be the RDRT. The minimum value of the RDRT determined from multiple measurements may comprise processing and may not or need not comprise buffering and/or other waiting times.

The network node, e.g. device 200, conventionally only knows when it correctly received the SR and/or BSR and/or data transmission. The network node, e.g. device 200, conventionally does not know how long the radio device, e.g. UE or device 100, waits for the transmission and/or whether it goes through retransmission and/or how many retransmissions the radio device, e.g. UE or device 100, has taken.

A fourth step, which is combinable with the three steps of the embodiment above or any other embodiment disclosed herein, comprises scheduling the radio device, e.g. the device 100, according to the determined RDRT 620 as follows:

4. The network node, e.g. gNB or device 200, takes into account RDRT 620 information in its scheduling:
With knowledge of both PDB and the RDRT 620 information, the network node, e.g. gNB or device 200, can provide faster and/or shorter transmission opportunities (e.g. shorter transmission time intervals, TTIs, or sTTIs) for radio devices, e.g. UEs or devices 100, with larger RDRT 620, this way ensuring that the PDB and/or end-to-end delay requirements are met.
In a further sub-embodiment, which is combinable with any other embodiment disclosed herein, the network node, e.g. gNB or device 200, can prioritize scheduling a radio device, e.g. UE or device 100, with a larger RDRT 620 before other network nodes, e.g. UEs or devices 100, in order to fulfil PDB and/or end-to-end delay requirements of all users.
In a further sub-embodiment, which is combinable with any other embodiment disclosed herein, the network node, e.g. gNB or device 200, acquires the time when the TSN packets are ingressed into the telecommunications, e.g. 5G, system 502 from the radio device, e.g. UE or device 100, side. This information can be provided from the TSN Centralized Network Configuration (CNC). With the knowledge of the RDRT 620, the network node, e.g. gNB or device 200, knows more accurately when the TSN packet might be available for transmission on the air interface and can accordingly schedule transmission opportunities for these packets so that (a) the time to wait for transmission is minimized, and/or (b) the scheduled transmission opportunities do not occur before the packets are available for transmission, and/or (c) the waste, due to resource over-provisioning for jitter at the air interface (e.g., when packet is available for transmission), is reduced.

FIGS. 6B and 6C schematically show two further timelines for configured grant (CG) resource allocations. Like instances in times or time spans in FIGS. 6A, 6B and 6C are labeled with like reference signs.

In FIG. 6B, when determining how to allocate CG resources the network node, e.g. gNB or device 200, uses the arrival time (t₁=application packet available for transmission from an end station 510) and configured grant periodicity 626 provided by Time Sensitive Communication (TSC) Assistance Information (TSCAI). According to the 3GPP document TS 23.501 V16.3.0, TSC comprises a communication service that supports deterministic communication and/or isochronous communication with high reliability and availability. It is about providing packet transport with QoS characteristics such as bounds on latency, loss, and reliability, where end systems and relay/transmit nodes can be strictly synchronized.

The network node, e.g. gNB or device 200, does not know the actual RDRT at reference sign 620. Thus, it estimates a value T_{RDRT} at reference sign 620 as the delay between an application packet transmission from the end station 510, e.g. at time t₁ at reference sign 602, until the packet is received at the top of the first layer, e.g. 3GPP Layer 2, in the radio device, e.g. UE or device 100, e.g. at time Tᵢ at reference sign 604. The network node, e.g. gNB or device 200, is aware of a processing delay T_{P-UE} at reference sign 622, from the reception of the packet at the top of the first layer, e.g. 3GPP Layer 2, until the packet is ready for transmission at the second layer, e.g. the PHY layer, e.g. at reference sign 606. The network node, e.g. gNB or device 200, takes into account t₁+T_{RDRT}+T_{P-UE} and the PDB at reference sign 624 to determine the time range, e.g. at reference sign 628, within which it can allocate resources, e.g. in terms of time and frequency, for a CG. In an exemplary embodiment, the transmission starts on the allocated resource at T_{TS} at reference sign 608.

The more accurate the value used for T_{RDRT} at reference sign 620 is, the more accurate is the flexibility in selecting one or more CG resources, e.g. within the CG resource allocation range 628. If the estimation of T_{RDRT} at reference sign 620 is too small, there is a risk that the CG resource(s) may start too early, e.g. when the packet is not yet ready, e.g. for radio transmission. If the estimation of T_{RDRT} at reference sign 620 is too large, there is an unnecessary restriction on the CG resource allocation range 628, e.g. realizing the PDB 624 may be threatened. For example, the otherwise unknown value of T_{RDRT} at reference sign 620 is conventionally estimated conservatively large without the method disclosed herewith. A “safe” or conservative value of the estimated RDRT is, e.g., used when initially determining an appropriate starting time of the allocated UL Data Radio Bearer (DRB) resources.

In FIG. 6C, a network node, e.g. gNB or device 200, can determine an accurate value for T_{RDRT} at reference sign 620 as follows: the radio device, e.g. UE or device 100, has a telecommunications, e.g. 5G, reference time that has been adjusted to reflect the DL propagation delay (e.g. ½ the timing advance value applicable to that radio device, e.g. UE or device 100, is used as the DL propagation delay). The TSN application in end station 510 sends an UL packet which is timestamped (=Tᵢ at reference sign 604) upon arrival at the radio device, e.g. UE or device 100, e.g. at the 3GGP Layer 2 buffer. The radio device, e.g. UE or device 100, includes the time stamp Tᵢ (at reference sign 604) as part of the UL packet transmission to the network node, e.g. gNB or device 200. The network node, e.g. gNB or device 200, performs an egress timestamp (=Tₑ at reference sign 610), e.g. t2a or t2b at reference signs 710 and 712, respectively, in FIG. 7, upon reception of the UL packet and determines Tₑ−t₁=Tₑ−Tᵢ+T_{RDRT}, which can be rewritten as T_{RDRT}=Tᵢ−t₁. By expressing t₁ at reference sign 602 with respect to the telecommunications, e.g. 5G, reference time and transmitting the corresponding first and/or second time stamp comprised in the packet, the network node, e.g. gNB or device 200, can determine T_{RDRT} at reference sign 620. The network node, e.g. gNB or device 200, can adjust allocated CG resources (e.g. in terms of setting T_{TS} at reference sign 608 for example within the CG resource allocation range 628) to reflect the calculated value of T_{RDRT} at reference sign 620. E.g. CG resources can be adjusted and/or allocated earlier in time.

After the CG periodicity 626 expires, a new packet may arrive at the time t₂ at reference sign 614 from an end station 510, e.g. at the DS-TT port of device 100.

The method and timelines discussed in the context of FIGS. 6A to 6C and FIG. 7 may correspond to the first variant of the methods 300 and 400 of, respectively, determining the RDRT and scheduling the radio device accordingly.

According to the second and third variants of methods 300 and 400 of, respectively, determining the RDRT and scheduling the radio device accordingly, the first steps of exemplary embodiments are as follows, wherein steps 1 to 3 apply to both the second and third variant, whereas only in the second variant steps 4 to 6 are performed at the radio device, e.g. the device 100:
1. The radio device, e.g. UE or device 100, timestamps the arrival of a special payload (e.g. a gPTP sync frame) at the UE-DS-TT 506 (=timestamp T_{A}, e.g. corresponding to the time stamp t₁ at reference sign 602) as the first layer 506.
2. The radio device, e.g. UE or device 100, can also timestamp the arrival of the special payload when it arrives at the top of the PDCP layer (=timestamp T_{B}, e.g. corresponding to the time stamp Tᵢ at reference sign 604) as the second layer 508. In an alternative step, the radio device, e.g. UE or device 100, can also timestamp the arrival of the special payload when it arrives at the RLC layer (=timestamp T_{B′}, e.g. corresponding to the time stamp Tᵢ at reference sign 604) as the second layer 508.
3. The primitive used to send the special payload from the UE-DS-TT 506 to the PDCP layer, e.g. as the second layer 508, can include an implementation specific indication that the payload consists of a gPTP sync frame, e.g. such that the radio device, e.g. UE or device 100, will know when it needs to perform timestamp T_{B} when data arrives at the top of the PDCP layer as the second layer 508.
4. The RDRT at reference sign 620 is determined from the difference of timestamp T_{B} and timestamp T_{A} (T_{RDRT}=T_{B}−T_{A} or T_{B′}−T_{A}).
5. The radio device, e.g. UE or device 100, includes timestamp T_{A} (e.g. at reference sign 602) in a gPTP sync message (per legacy concepts) and also adds the RDRT 620 to the gPTP sync message (new) by re-accessing the gPTP sync message whenever it knows it is dealing with special payload.
6. The network node, e.g. gNB or device 200, will need some indication if it has received special payload so that it can extract the RDRT 620 from a MAC PDU. Otherwise, it just blindly performs deep packet inspection (DPI) attempting to find a gPTP sync frame.

Concerning step 6 in the above exemplary embodiments, possible sub-embodiments are:
The gPTP messages are sent using a specific PDU session applicable for sending gPTP messages. When the network node, e.g. gNB or device 200, receives a packet that is not from this PDU session, it does not perform DPI. When the network node, e.g. gNB or device 200, receives a packet that is from this PDU session, it needs to further check the header of the packet to know if this is a gPTP sync frame. Note that per the 3GPP Technical Specification Group on Service and System Aspects subgroup 2 (SA2) agreements, section 5.27.1.2.2 of the document TS 23.501 V16.2.0 indicates that gPTP messages are transmitted on a QoS flow that complies with the residence time upper bound requirement specified in IEEE. As such, the configuration of a DRB and a General Packet Radio Service (GPRS) Tunneling Protocol for carrying user data (GTP-U) tunnel required to support a QoS flow will result in a DRB ID and GTP-U tunnel ID that both map to the same QoS Flow ID (QFI). This means that, whenever a network node, e.g. gNB or device 200, receives an UL payload on a given DRB resource, it always knows if the corresponding QFI supports the transmission of gPTP messages (i.e. the network node, e.g. gNB or device 200, can choose to perform DPI of MAC PDUs only if they are sent using a DRB that is known to support the transmission of gPTP sync messages).
In an alternative step to the above step 6, the gPTP message is transparently transmitted to the CN (e.g. UPF 524) without network node, e.g. gNB or device 200, inspection. The gPTP message is instead inspected at the CN and the RDRT 620 is provided from the CN to the network node, e.g. gNB or device 200. The CN can choose to transmit the RDRT 620 every time it receives a corresponding gPTP message, or send the averaged RDRT 620 after every X number of gPTP messages (where X is a positive integer), or only send the updated RDRT 620 if there is a big difference from a previous measured RDRT.

With the proposed methods and devices, concerning enhancement to 3GPP Release 16 a sub-embodiment, that is combinable with any embodiment, comprises the possibility to measure the RDRT 620 after PDU session establishment, which allows to measure variations in the RDRT 620 that may change with every PTP and/or gPTP updating interval.

The radio device 100 (e.g., a UE) and the network node 200 (e.g., a gNB or eNB) are time-synchronized (or briefly: synchronized), i.e., local clocks at each of the radio device 100 and the network node 200 used for setting the time stamps are synchronized. The synchronization is achieved by delivering a time reference from either one of the radio device 100 and the network node 200 to the other one, or by receiving the time reference at each of the radio device 100 and the network node 200 from a centralized time source, e.g. grandmaster clock 520 or TSN grandmaster clock 522.

The time reference may be transmitted (e.g., broadcasted) in SIB and/or RRC signaling. Any existing method of delivering the time reference may be used or extended for implementing the synchronization.

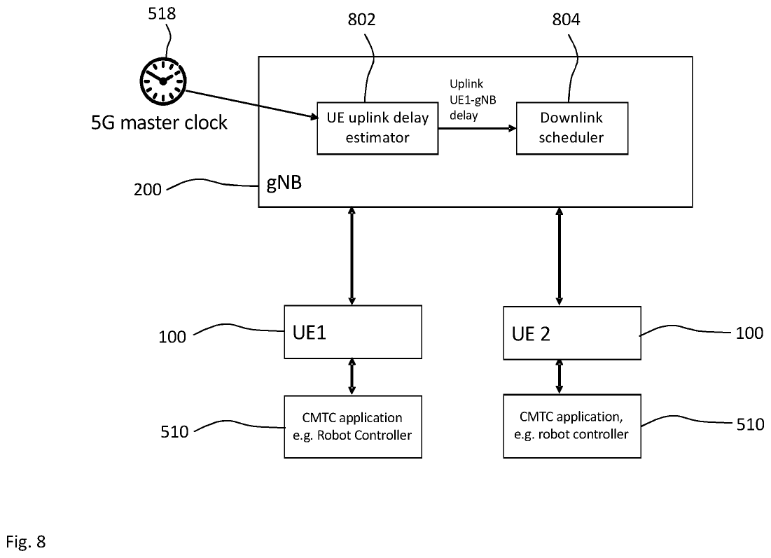

As further embodiments, considering controller to controller communication where deterministic latency performance between two radio devices, e.g. UEs or two copies of the device 100, is expected, based on the acquired knowledge of the RDRTs 620 of each radio device, the network node, e.g. gNB or device 200, can dynamically change resource allocation, e.g. CG resource allocation range 628, of the other leg of the radio communication, as schematically shown in FIG. 8, wherein an UL delay estimator 802 corresponding to the first radio device UE1 at reference sign 100 on the left-hand side provides the estimated UL delay to the DL scheduler 804 of the second radio device UE2 at reference sign 100 on the right-hand side.

To enable predictable and very low latency for industrial applications, where a cycle time is known in advance, IEEE TSN specific time aware traffic scheduling is provided, as described, e.g., in the document IEEE 802.1Qbv-1315. To enable this new type of transmission, gates are proposed which are associated with each queue. The time aware gates enable transmissions from each queue known to a predefined time scale. For a given queue, the transmission gates can be in two states: open or closed.

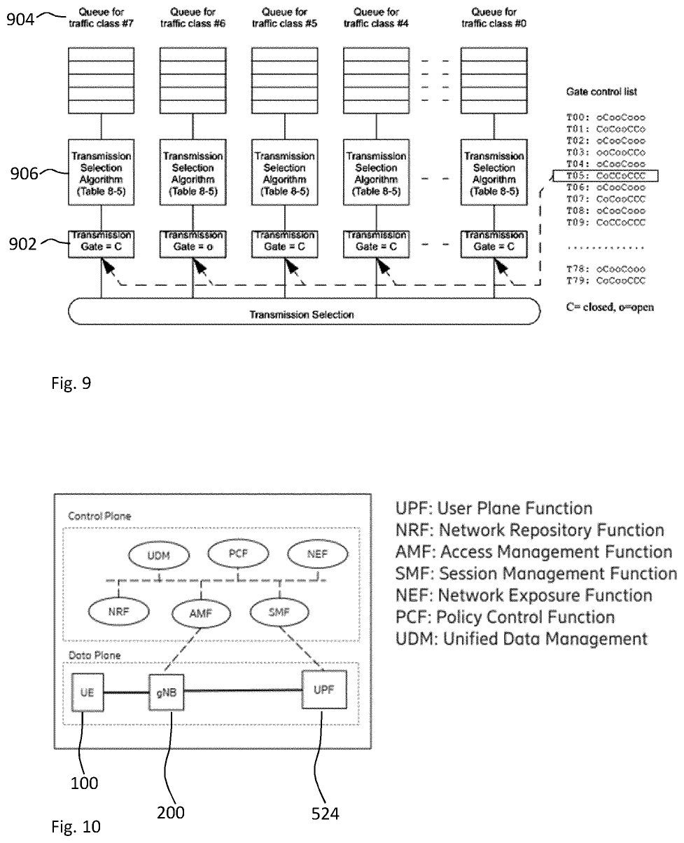

FIG. 9 schematically shows TSN specific time aware traffic scheduling or transmission selection with gates according to the document IEEE 802.1Qbv-2015, wherein gates 902 are associated with each queue 904. The time aware gates 902 enable transmissions from each queue 904 known to a predefined time scale. For a given queue 904, the transmission gates 902 can be in two states: “open” or “closed”.

Each transmission gate 902 relates to a traffic class associated with a specific queue 904, with potentially multiple queues 904 associated with a given port. A gate 902 at any instance of time can be either turned on or off (“open” or “closed”). This mechanism is time aware and can be based on, e.g., a PTP or gPTP application within the bridge 526 or end station 510. This mechanism allows execution of a gate control list to be precisely coordinated across the network 500 (e.g. the TSN 504), enabling scheduled transmissions for a given class of traffic across the TSN 504.

As seen in the TSN stream setup steps, the given information about the schedule of the TSN streams is calculated by a CNC entity, based on the user to (e.g. telecommunications) network requirements (see e.g. section 46.2.3.6 of the document IEEE 802.1Qcc) provided by the end talker and listener (or a CUC entity).

FIG. 10 schematically shows a telecommunications, e.g. 5G, network architecture comprising in the data plane one or more radio devices, e.g. UEs or copies of the device 100, one or more network nodes, e.g. gNBs or copies of the device 200, and a UPF 524. Standard management objects defined in the document IEEE 802.1Qvc are used for configuring transmission schedules on each TSN bridge 526 by a CNC entity via a remote network management protocol (e.g. step 906 in the TSN stream setup phase in FIG. 9).

FIG. 11 shows a schematic block diagram for an embodiment of the device 100. The device 100 comprises one or more processors 1104 for performing the method 300 and memory 1106 coupled to the processors 1104. For example, the memory 1106 may be encoded with instructions that implement at least one of the modules 102 and 108.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1106, transmitter and/or receiver functionality. For example, the one or more processors 1104 may execute instructions stored in the memory 1106. Such functionality may include providing various features and steps discussed herein, including any of the benefits disclosed herein. The expression “the device being operative to perform an action” may denote the device 100 being configured to perform the action.

As schematically illustrated in FIG. 11, the device 100 may be embodied by a radio device 1100, e.g., functioning as a UE. The radio device 1100 comprises a radio interface 1102 coupled to the device 100 for radio communication with one or more network nodes, e.g., functioning as a receiving and/or transmitting base station.

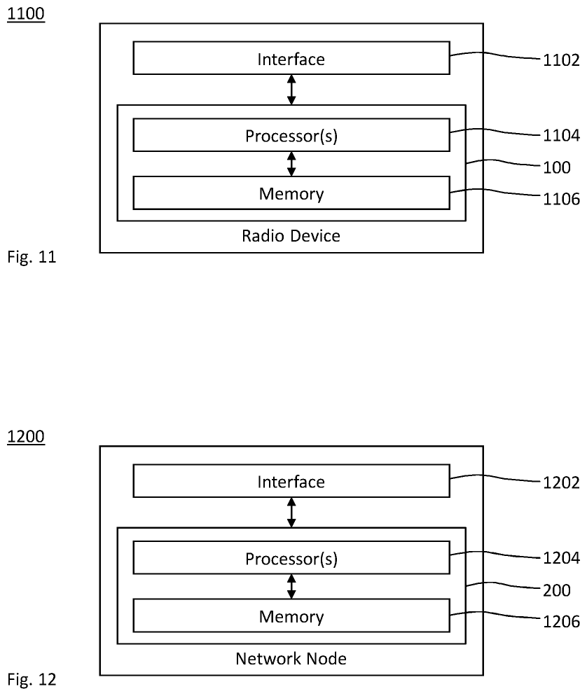

FIG. 12 shows a schematic block diagram for an embodiment of the device 200. The device 200 comprises one or more processors 1204 for performing the method 400 and memory 1206 coupled to the processors 1204. For example, the memory 1206 may be encoded with instructions that implement at least one of the modules 202 and 208.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1206, receiver and/or functionality. For example, the one or more processors 1204 may execute instructions stored in the memory 1206. Such functionality may include providing various features and steps discussed herein, including any of the benefits disclosed herein. The expression “the device being operative to perform an action” may denote the device 200 being configured to perform the action.

As schematically illustrated in FIG. 12, the device 200 may be embodied by a network node 1200, e.g., functioning as a receiving and/or transmitting base station. The network node 1200 comprises a radio interface 1202 coupled to the device 200 for radio communication with one or more transmitting and/or receiving stations, e.g., functioning as a transmitting and/or receiving radio device or UE.

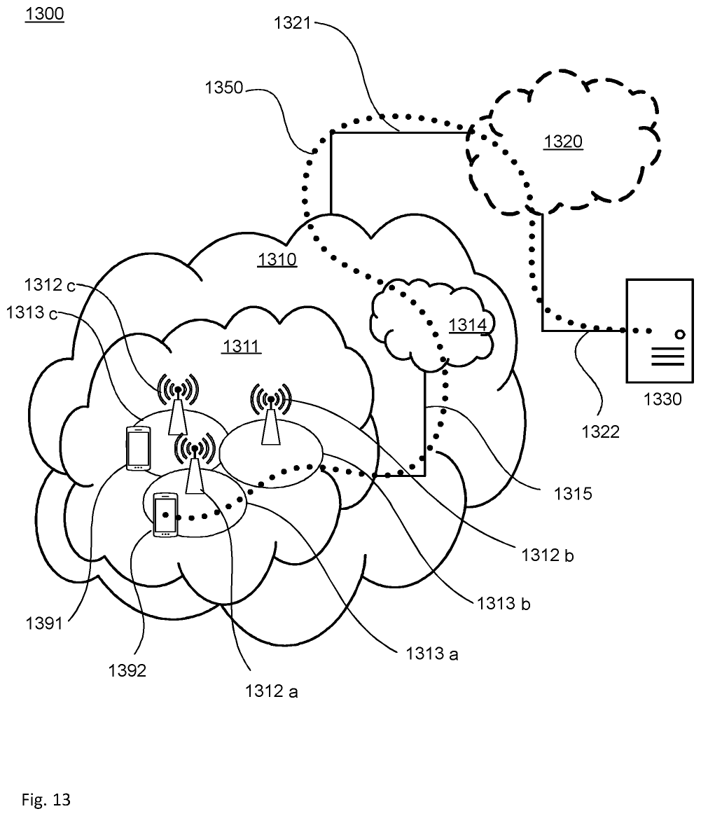

With reference to FIG. 13, in accordance with an embodiment, a communication system 1300 includes a telecommunications network 1310, such as a 3GPP-type cellular network, which comprises an access network 1311, such as a radio access network, and a CN 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the CN 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

The telecommunications network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunications network 1310 and the host computer 1330 may extend directly from the CN 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the CN 1314, any intermediate network 1320 and possible further infrastructure (not shown) as intermediaries. The OTT connection 1350 may be transparent in the sense that the participating communication devices through which the OTT connection 1350 passes are unaware of routing of UL and DL communications. For example, a base station 1312 may not or need not be informed about the past routing of an incoming DLk communication with data originating from a host computer 1330 to be forwarded (e.g., handed over) to a connected UE 1391. Similarly, the base station 1312 need not be aware of the future routing of an outgoing UL communication originating from the UE 1391 towards the host computer 1330.

By virtue of the methods 300 and 400 being performed by any one of the UEs 1391 or 1392 and/or any one of the base stations 1312, respectively, the performance of the OTT connection 1350 can be improved, e.g., in terms of increased throughput and/or reduced latency.

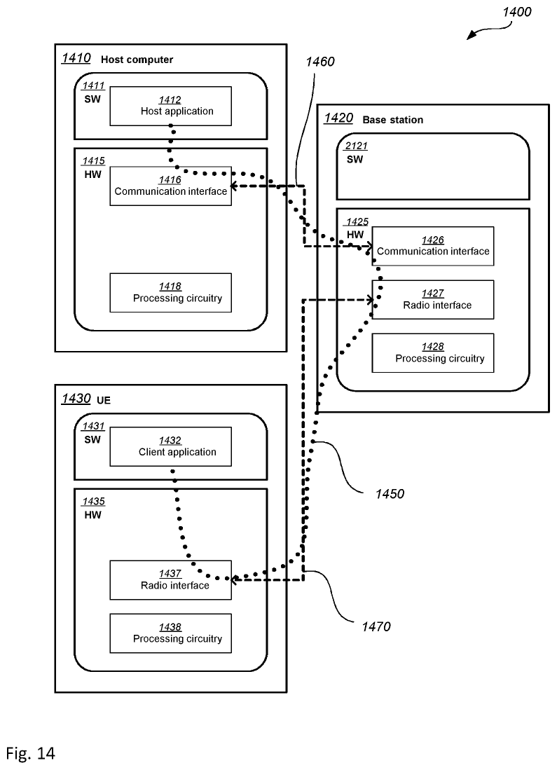

Example implementations, in accordance with an embodiment, of the UE, base station and host computer discussed in the preceding paragraphs will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420. The communication interface 1426 may be configured to facilitate a connection 1460 to the host computer 1410. The connection 1460 may be direct or it may pass through a CN (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, any one of the base stations 1312a, 1312b, 1312c and any one of the UEs 1391, 1392 of FIG. 13, respectively. This is to say, the inner workings of these entities may be as shown in FIG. 14 and independently, the surrounding (e.g. telecommunications) network topology may be that of FIG. 13.

In FIG. 14, the OTT connection 1450 has been drawn abstractly to illustrate the communication between the host computer 1410 and the use equipment 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the (e.g. telecommunications) network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

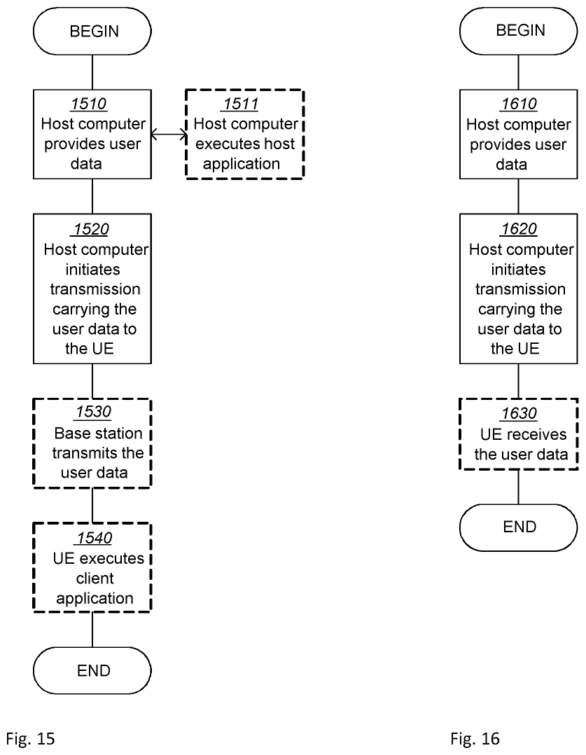

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from above description, embodiments of the technique allow for an enhanced scheduling mechanism to enable TSN communication over a 5G system. Dynamic radio resource allocation for a radio device to the radio communication is facilitated, by exploiting a network node's knowledge of the RDRT, e.g. for scheduling UL and/or DL transmissions. Alternatively or in addition, knowing the actual RDRT gives the advantage of the network node, e.g. gNB, having a wider (than conventional) time range of possible UL DRB resources that it can allocated while still meeting the PDB and/or end-to-end delay requirements. Further alternatively or in addition, available radio resources can be more efficiently used.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method of determining a radio device residence time RDRT for a radio device in radio communication with a network node of a telecommunications network, the method comprising the steps of:
setting, at the radio device, a first time stamp of a packet of the radio communication, wherein the first time stamp is indicative of a time of handling the packet at a first layer of a protocol stack at the radio device; and
transmitting the packet to the network node through a second layer of the protocol stack, the second layer being below the first layer in the protocol stack, the packet comprising at least one of
the first time stamp of the packet for determining the RDRT based on a difference between the first time stamp and a second time stamp of the packet, wherein the packet is configured to initiate setting the second time stamp upon handling the packet at the telecommunications network,
the RDRT determined based on a difference between the first time stamp of the packet and a second time stamp of the packet set at the radio device, wherein the second time stamp is indicative of a time of handling the packet at the second layer of the radio device, and
the first time stamp of the packet and a second time stamp of the packet set at the radio device, wherein the second time stamp is indicative of a time of handling the packet at the second layer of the radio device, wherein the packet is configured to initiate determining, at the telecommunications network, the RDRT based on a difference between the first time stamp and the second time stamp.

2. The method of claim 1, wherein at least one of:
the packet is configured to initiate the setting of the second time stamp upon handling the packet at the network node;
the packet comprising the RDRT is transmitted to the network node; and
the packet is configured to initiate the determining of the RDRT at the network node.

3. The method of claim 1, wherein transmitting the first time stamp further initiates:
setting the second time stamp of the packet at the network node.

4. The method of claim 1, further comprising the step of:
setting the second time stamp of the packet at the radio device.

5. The method of claim 4, further comprising the step of:
determining, at the radio device, the RDRT based on the difference between the first time stamp of the packet and the second time stamp of the packet set at the radio device.

6. The method of claim 1, wherein handling the packet at the first layer and/or at the second layer comprises at least one of:
arrival of the packet at the respective layer; and
forwarding of the packet from the respective layer of the protocol stack at the radio device to another layer in the protocol stack at the radio device or to the network node.

7. The method of claim 1, wherein
the first layer of the protocol stack handles the packet according to a time sensitive network, TSN and and/or the first layer and/or the second layer of the protocol stack handles the packet according to a radio access technology RAT of the radio communication,
the first layer comprises: a TSN application layer of the protocol stack; a translator configured to translate packets between a domain of the TSN and a domain of the radio communication; an ingress point to the TSN application layer, which is above a RAT of the radio communication within the protocol stack at the radio device; and/or an ingress point to layers comprising a RAT of the radio communication within the protocol stack at the radio device, which is below a TSN application layer, and
the second layer comprises: a Packet Data Convergence Protocol layer of the radio device; a Radio Link Control layer of the radio device; a Medium Access Control layer of the radio device; and/or a Physical layer of the radio device.

8-9. (canceled)

10. The method of claim 1, further comprising the step of:
receiving, at the radio device, a message indicative of scheduling information of at least one of an uplink UL transmission from the radio device and a downlink DL transmission to the radio device,
wherein the scheduling information is based on the determined RDRT.

11. The method of claim 10, wherein the scheduling information is further based on at least one of a packet delay budget PDB and an end-to-end delay requirement.

12. The method of claim 11, wherein the PDB or the end-to-end delay requirement is provided by or received from at least one of:
a time sensitive network;
a Centralized User Configuration entity;
the radio device; and
an application of the radio device.

13. The method of claim 10, wherein
the scheduling information is indicative of a transmission opportunity, which is a function of the determined RDRT.

14. The method of claim 13, wherein
the scheduling information is indicative of a start time of the transmission opportunity, and wherein
the scheduling information is based on the determined RDRT by indicating a first start time if a first value of the RDRT is determined and indicating a second start time if a second value of the RDRT is determined,
a time span until the first start time is less than a time span until the second start time,
the first value of the determined RDRT is greater than the second value of the determined RDRT, and
the time span is measured from i) the time that the packet is available or ready for transmission at the second layer or ii) the time of handling the packet at the first layer.

15-26. (canceled)

27. A method of scheduling a radio device in radio communication with a network node of a telecommunications network, the method comprising the steps of:
receiving, from the radio device, a packet of the radio communication, the packet comprising at least one of
a first time stamp of the packet set at the radio device for determining a radio device residence time, RDRT, based on a difference between the first time stamp and a second time stamp of the packet, wherein the first time stamp is indicative of a time of handling the packet at a first layer of a protocol stack at the radio device-, wherein the packet is received through a second layer of the protocol stack at the network node, the second layer being below the first layer in the protocol stack, wherein the packet is configured to initiate setting the second time stamp upon handling the packet at the telecommunications network,
the RDRT determined based on a difference between a first time stamp of the packet and a second time stamp of the packet set at the radio device, wherein the first time stamp is indicative of a time of handling the packet at a first layer of a protocol stack at the radio device, wherein the second time stamp is indicative of a time of handling the packet at a second layer of the protocol stack at the radio device, the second layer being below the first layer in the protocol stack, and
a first time stamp of the packet and a second time stamp of the packet set at the radio device, wherein the first time stamp is indicative of a time of handling the packet at a first layer of a protocol stack at the radio device, wherein the second time stamp is indicative of a time of handling the packet at a second layer of the protocol stack at the radio device, the second layer being below the first layer in the protocol stack, wherein the packet is configured to initiate determining, at the telecommunications network, the RDRT based on a difference between the first time stamp and the second time stamp; and
transmitting a message indicative of scheduling information of at least one of an uplink UL transmission from the radio device and a downlink DL transmission to the radio device, wherein the scheduling information is based on the determined RDRT.

28. The method of claim 27, further comprising:
setting the second time stamp at the network node.

29. The method of claim 28, wherein the second time stamp is set at least at one of:
arrival of the packet at the network node,
egress to a first layer of the protocol stack at the network node, and
egress to the telecommunications network or a TSN.

30. The method of claim 29, wherein the first layer comprises at least one of an Internet Protocol IP layer, a transport layer and an application layer.

31. The method of claim 27, further comprising the step of:
determining the RDRT based on a difference between the first time stamp of the packet and the second time stamp.

32. The method of claim 31, wherein the determining of the RDRT is further based on a time offset comprising i) a duration of handling the packet at the second layer and/or ii) a duration of radio propagation of the transmitted packet from the radio device to the network node.

33. The method of claim 27, wherein the step of receiving the packet comprises:
receiving one or more re-transmissions of the packet;
decoding the packet at the network node; and/or
combining segments of the packet at the network node.

34. The method of claim 27, wherein
the scheduling information is indicative of a transmission opportunity, which is a function of the determined RDRT,
the RDRT is determined for each of a first radio device and a second radio device,
the scheduling information is indicative of a first start time of the transmission opportunity for the first radio device and a second start time of the transmission opportunity for the second radio device, and
the first start time is earlier than the second start time if the RDRT determined for the first radio device is greater than the RDRT determined for the second radio device.

35-49. (canceled)
